(19) United States
(12) Patent Application Publication
(10) Pub. No.: US 2005/0193993 A1
(43) Pub. Date: Sep. 8, 2005

(54) Fuel vapor systems for internal combustion engines

(76) Inventor: Thomas D. Dale, Egg Harbor Township, NJ (US)

Correspondence Address: FISH & RICHARDSON PC, 225 FRANKLIN ST, BOSTON, MA, 02110, US

(21) Appl. No.: 10/994,816

(22) Filed: Nov. 22, 2004

Related U.S. Application Data
(60) Provisional application No. 60/550,159, filed on Mar. 4, 2004.

(51) Int. Cl. F02G 5/00

(52) U.S. Cl. 123/549; 123/557

(57) ABSTRACT

Pressurized fuel vaporizers for engines. Fuel is vaporized under substantial super-atmospheric pressure. Surfaces are heated by the engine's electrical system. Vapor heated by a wall bounding a vaporization space turbulently mixes with incoming liquid spray, helping to produce new vapor. Useful for cold start, liquid spray reaching a rapidly heated impact plate is vaporized. Multiple heat-transfer surfaces are exposed to the same vapor volume, one, a surface of revolution surrounding the spray, another, a transverse surface across the spray. The spray is in pulses. Glow plugs are arranged perpendicular to heat-distributing members. A volume-surrounding wall receives heat from an annular medium, e.g. an annular conductive plate or an annulus of phase change material, such as low melting point metal, e.g. sodium. Air is shown excluded from the pressure chamber. A fuel vaporizer dedicated to a single combustion region has a cup-shaped vaporization chamber heated by a central heater in opposition to liquid spray. Bottom and side surfaces of the cup are constructed to promote mixing circulation. Liquid fuel injection is synchronized with timing of the engine. In such a system also having a vapor injection valve synchronized with engine timing, the interval between operation of the valves is controlled to enable heat-transfer to vaporize the fuel and build-up pressure. The heating coil of a glow plug is electrically insulated from, but thermally conductively related to, its exterior tube predominantly by fine powdered glass and the exposed stem of the glow plug is pressure-sealed by high temperature seal glass.

### CLAIM OF PRIORITY

This application claims priority under 35 USC § 119(e) from U.S. Provisional Patent Application Ser. No. 60/550,159, filed on Mar. 4, 2004, the entire contents of which are herein incorporated by reference.

### TECHNICAL FIELD

Systems that transform liquid fuel into fuel vapor to improve combustion in internal combustion engines.

### BACKGROUND

The manner in which fuel is provided to an engine significantly affects fuel efficiency and exhaust emissions. In a piston engine with a carburetor, liquid gasoline is introduced centrally to a flow of combustion air, following which the air-fuel mixture is divided and distributed to the engine cylinders. In a piston engine with fuel injectors at the cylinders, pressurized liquid fuel is forced through nozzles of the injectors to inject sprays of liquid fuel particles. The sprays are injected into combustion air at the inlet ports of the cylinders or directly into the combustion regions. Incomplete combustion of the fuel in these and other engines detrimentally affects fuel economy and produces harmful emissions. Over many decades suggestions have been made to pre-vaporize fuel as a way to improve fuel efficiency and decrease emissions of internal combustion engines, but no acceptable solution has been found.

### SUMMARY

For a running engine, a vaporization chamber (or vapor chamber) under substantial super-atmospheric pressure has a pulsed, pressurized fuel spray injector spaced from a heated heat-transfer surface. Vapor at pressure, previously produced by spray heated by the heat-transfer surface, recirculates adjacent the injector. The vapor intercepts and turbulently mixes with injected liquid spray. This assists in producing more vapor, while the mixture is heated further by the heat-transfer surface. A vapor passage from the chamber conducts the fuel vapor to the engine in a manner preserving substantial super-atmospheric pressure in the chamber. Thus the vapor density associated with the pressure condition of the chamber helps produce fuel vapor. Time delay and flow conditions between liquid injection into the vaporization chamber and entry of the fuel into a combustion region of the engine can promote mixing of vapor with any residual atomized fuel particles. With fuel such as gasoline it is found that effective vaporization and transport from a central vapor chamber to cylinders of an engine can be produced without use of airflow in the vapor chamber. In other instances, a limited input of pressurized air may facilitate operation. The air can aid in recirculation of the heated vapor and mixing with the injected liquid spray. In either system, the motive power of the introduced liquid spray, itself, can produce strong turbulent mixing action. If air is to be introduced to the vapor chamber, it may be admitted as cross-jets at the nozzle at which the liquid spray emerges to promote atomization of the liquid spray into finer particles.

In another arrangement, a pressurized vaporization chamber is dedicated to each engine cylinder or other combustion region of the engine. A vapor injection nozzle may be arranged to inject the fuel vapor into the air inlet port of the combustion region or directly into the region. The level of super-atmospheric pressure in the vapor chamber is a function of the energy of the incoming liquid spray, the heated vaporizing action and valving of vapor discharge from the chamber. The valving may be electrically activated in time coordinated with engine timing or may be spring-loaded to be responsive to pressure in the chamber. The value of the super-atmospheric pressure employed depends upon the type of engine involved. In any event, the fuel vapor emerges at pressure sufficient to propel the vapor to its point of utilization in the engine. Embodiments of such dedicated vaporizers operate with air excluded from the vapor generating chamber.

In some embodiments using a dedicated vapor generating chamber for each combustion region of an engine, a pulse of liquid fuel spray into each combustion region is sized to form a single fuel charge. This liquid spray can be timed in advance of vapor discharge from the chamber to provide an appropriate heating interval. The duration of the interval, the size of the injected liquid pulse, and the timing of vapor discharge is all under control of the engine management computer. In the case of the vaporizer being associated with a cylinder of a reciprocating diesel engine, for instance, the duration of the interval and amount of heating is controlled to produce a substantial pressure build-up in the vaporization chamber. This can enable injection of diesel vapor at very high pressure directly into the combustion region of the diesel cylinder, suitably timed with the beginning of the power stroke.

In the context of this description, the term “substantial super-atmospheric pressure” in the vaporization chamber refers to pressures at least above 10 psig. It is preferred to employ pressures substantially higher, i.e., pressures in excess of 20 psig, up to about 80 psig for gasoline engines. For vaporization chambers that inject directly into engine cylinders, pressures that are much greater are appropriate. The system may be useful as the sole means of fuel delivery or in combination with other fuel delivery features such as injection of liquid fuel particles into the air system, e.g. for cold start, or into the combustion space, e.g. for diesel engines.

A vapor-producing arrangement for cold conditions, in a preferred construction, comprises a rapidly heated surface in the vapor chamber, which receives liquid fuel spray to produce initial vaporization.

In a particularly efficient construction, heat-transfer surfaces for both cold starting and running and for warm running conditions are associated with the same vapor-producing volume. In one construction, a heated heat-transfer surface surrounds the spray, e.g. a cylindrical heated heat-transfer surface surrounds a conical spray from an injector. This heat-transfer surface is located at a sufficient distance from the injector to enable much of the vaporizing action to occur in free-space during warm running conditions. A second heat-transfer surface, extending transversely across the axis of the injector, is located in position to be wetted by initial spray. This second heat-transfer surface is rapidly heated to produce heated vapor to enable operation in cold conditions. In some designs, this second heat-transfer surface can be used for cold starting, cold running and warm running of the engine.

Heating of the heat-transfer surfaces is preferably electrical. In some designs an electric heater for a heat-transfer surface is isolated from the vapor volume while in other cases it is directly exposed to the fuel.

Glow plugs (i.e. electric heaters based on resistance heating of a projection such as a tube) are found effective for the vapor generation. Long life glow plugs feature a durable construction. Preferred features include a central resistor predominantly of platinum and an electrically insulative, heat-conductive fine powder substantially comprising glass that fills the space between the resistor element and a surrounding heat-conductive tube. A heat resistant seal of high temperature pressure seal glass.

In a number of advantageous arrangements a glow plug is employed to heat an intermediate heat-conductive medium which extends from the glow plug to the member defining the active heat-transfer surface. For example, glow plug heating can be employed with an annular heat-conductive medium provided between glow plugs and a cylindrical wall that defines the vaporizing heat-transfer surface. In one instance the annular conductive medium is a conductive metal ring, such as an annular aluminum plate, which is engaged by the glow plugs and in conductive heat-transfer relationship with the wall member. In another instance this annular conductive medium is heat-conductive metal, which may be liquid under operating conditions and the heat associated with the phase change of this metal from solid to liquid and vice versa can serve as a heat sink and produce stable temperature conditions around the annulus.

Rapid start-up vapor generation is preferably enabled by glow plug heating of a heat-transfer surface defined by a thin, low mass conductive plate wetted by the liquid spray. In embodiments of this feature the glow plug and the plate are both exposed to heat the fuel.

In some embodiments a heat-transfer surface in the form of a surface of revolution is centered on the axis of a glow plug, extending outwardly from it. This is an advantageous construction for vapor generators dedicated to individual cylinders of an engine. In an advantageous construction the dedicated vapor generator is generally cup-shaped, with a central glow plug protruding at the center toward an aligned liquid spray injector nozzle, the glow plug being exposed for producing vapor and in a heating relationship with the cup bottom, and, via the cup bottom, with the upwardly extending sidewalls of the cup. The cup bottom may be shaped as a deflective surface to guide the flow into a mixing motion. With higher pressures within the vapor chamber, the dimensions of the vapor chamber may be reduced.

Particular features of fuel vapor systems will now be described.

One particular feature is a fuel vaporizer for an internal combustion engine, the fuel vaporizer comprising: a closed pressure chamber defining a volume, a heat-transfer surface associated with the volume and arranged to be heated, and a liquid fuel supply system disposed to emit into the volume, under pressure, an expanding pattern of liquid fuel spray from at least one outlet spaced from the heat-transfer surface, the chamber and the liquid fuel supply system being constructed and arranged relative to the heat-transfer surface to establish between the at least one outlet and the heat-transfer surface a mixing domain in which the fuel spray, as it progresses through the volume from the outlet, is substantially heated and vaporized by mixing with recirculated, heated fuel vapor that previously has moved over and received added heat from the heat-transfer surface, the fuel vaporizer being associated with a vapor outflow passage which includes a flow control, the fuel vaporizer constructed and arranged to enable flow of pressurized fuel vapor to the engine while maintaining substantial super-atmospheric pressure within the volume in which vaporization occurs.

Embodiments of this feature may have one or more of the following features.

The fuel vaporizer is equipped with an electrical system that comprises a battery and electric source powered by the engine, wherein the heat-transfer surface is heated by electric power from the electrical system.

The fuel vaporizer is constructed to vaporize liquid fuel in substantial absence of airflow.

The fuel vaporizer is constructed to vaporize liquid fuel in presence of a limited flow of pressurized air into the pressure chamber.

The fuel vaporizer includes, as a liquid fuel supply system, a liquid fuel injection system constructed to inject controlled pulses of liquid fuel spray into the volume.

A liquid fuel supply system is constructed to produce pulses of pressurized liquid fuel flow to the spray system, each pulse of duration of about a second or more.

A liquid fuel supply system includes a controller to produce pulses of pressurized liquid flow of varying duration and/or frequency in response to fuel vapor demand.

In a preferred form, a liquid fuel injection system for the vaporizer comprises: a signal pulse generator constructed to produce a series of signal pulses according to the fuel requirements of the engine; a liquid fuel injector; a liquid fuel line connected to receive pressurized flow from an electric fuel pump and to supply the pressurized fuel to the liquid fuel injector, the liquid fuel injector being constructed and arranged, in response to the signal pulses, to produce through the outlet, pulses of diverging spray of liquid fuel.

The liquid fuel injection system for use with gasoline engines comprises an electric fuel pump constructed to provide liquid fuel for injection into the chamber at liquid pressure in the range of about 60 to 100 psig, and the fuel vaporizer is constructed to maintain pressure in the chamber volume in the range of about 30 to 80 psig, with the pressure of the liquid fuel being substantially greater than pressure in the chamber volume.

In a carburetor type system constructed to provide fuel vapor to a flow of combustion air, the vaporizer is constructed to maintain pressure in the chamber between about 65 and 75 psi.

In a gasoline fuel injection system, for instance for injection at the inlet port of a gasoline engine, the vaporizer is constructed to maintain pressure in the chamber between about 40 and 50 psi.

In embodiments so far described, the vaporizer is constructed to maintain the pressure of the liquid fuel greater than the pressure in the chamber, preferably greater by at least 5 psi, in some cases greater by 10 psi, 15 psi or much more.

The fuel vaporizer is constructed for association with a single combustion region of an internal combustion engine.

The liquid fuel injection system for a vaporizer dedicated to a single combustion region of an engine is constructed to inject a controlled pulse of liquid fuel spray into the chamber of the vaporizer in a timed relationship with the engine and in amount suitable to charge the combustion region.

A fuel vaporizer dedicated to a single combustion region of an engine is constructed to provide liquid fuel at pressure above about 100 psig for injection as a liquid spray into the volume of the vaporizer, in many cases the pressure being above 150 psig.

The fuel vaporizer is constructed to vaporize diesel fuel and inject diesel fuel vapor for combustion in a diesel cylinder.

The liquid fuel supply system of the vaporizer is constructed to produce a spray having an axis and the heat-transfer surface is a surface of revolution axi-symmetric with the spray.

The heat-transfer surface of the vaporizer surrounds the spray, in preferred cases the spray is conical and the heat-transfer surface is substantially cylindrical.

The heat-transfer surface as a surface of revolution is defined by thermally conductive metal of thickness between about 1/16 to ⅛ inch.

The heat-transfer surface includes a transverse surface opposed to the spray. Embodiments of this feature have one or more of the following features. The transverse surface is of round form. The heat-transfer surface is effectively cup-shaped, including a transverse surface opposed to the spray and an outer wall portion surrounding the spray. The transverse surface is associated with, effectively, at least one electric heater. The transverse surface is associated with, effectively, at least one glow plug.

A fuel vaporizer is constructed for association with a single combustion region of an internal combustion engine, and has, effectively, a single glow plug, the glow plug being centrally disposed with respect to the transverse surface, the glow plug being substantially aligned with the spray.

A transverse heat-transfer surface opposed to the spray has a shape constructed to receive and deflect the spray in a mixing pattern, e.g. the transverse surface is a concave torroidal section.

The fuel vaporizer is constructed to both vaporize diesel fuel and inject diesel vapor.

The fuel vaporizer is constructed to both vaporize gasoline and inject gasoline vapor.

The fuel vaporizer has a heater which is associated with the heat-transfer surface and is exposed for direct contact with fuel in the volume.

The fuel vaporizer has a heater that is associated with the heat-transfer surface in a manner protecting the heater from contact with fuel in the volume.

The fuel vaporizer includes a conductive substance that may undergo phase change under operating conditions, which is in contact with a member defining the heat-transfer surface, the substance defining part of a heat-transfer path between a heater and the heat-transfer surface. The substance may be conductive metal that may be melted, e.g. sodium.

The fuel vaporizer has a heater associated with the heat-transfer surface comprising one or more glow plugs in conductive heat-transfer relationship with the heat-transfer surface.

A conductive heat-transfer medium extends from at least one glow plug to a member defining the heat-transfer surface.

A conductive heat-transfer medium extending from a glow plug to a heat-transfer surface is a thermally conductive annular ring surrounding and in thermal contact with the exterior of a wall which on its interior defines the heat-transfer surface.

The fuel vaporizer includes an electric heater comprising multiple glow plugs spaced apart along a member defining the heat-transfer surface.

In the fuel vaporizer, a spray produced by the liquid fuel supply system is directed along an axis, and the fuel vaporizer comprises a transverse member defining the heat-transfer surface, the surface being associated with an electrical heater that is powered by an electrical system of an engine and extending across the axis.

The fuel vaporizer includes a heated heat-transfer surface positioned for impact of liquid fuel spray under cold start conditions to vaporize the liquid, for providing fuel vapor for starting the engine or running the engine cold. In preferred embodiments, this heated heat-transfer surface is positioned for impact of spray is in a conductive heat-transfer relationship with at least one glow plug, for electric heating of the heat-transfer surface.

The fuel vaporizer has both a first and a second heat-transfer surface associated with respective heaters.

First and second heat-transfer surfaces are associated with a given volume within the chamber, the first heat-transfer surface being associated with a mixing domain and the second heat-transfer surface being disposed for impact by liquid fuel spray at least under cold conditions to vaporize impacting spray.

The fuel vaporizer produces an expanding pattern of liquid fuel spray distributed about an axis and a first heat-transfer surface is constructed to surround the spray at a distance spaced from the axis and a second heat-transfer surface extends across the axis of the spray.

The fuel vaporizer has a second heat-transfer surface that is defined by a perforated member of thermally conductive material.

The fuel vaporizer has a second heat-transfer surface associated with electric glow plug heating.

The fuel vaporizer has its vapor outflow passage arranged to discharge into a region of a combustion air conduit associated with an engine, and the flow control is a vapor control valve adapted to be actuated in response to engine power requirements to control flow of vapor into the air conduit. In a preferred embodiment, the region of the combustion air conduit is a venturi region.

The fuel vaporizer is associated with an internal combustion engine having multiple combustion regions, and the vapor outflow passage of the vaporization chamber is arranged to supply a set of fuel vapor injectors each communicating directly or indirectly with a respective combustion region of the engine, the vapor injectors adapted to be actuated in response to power requirements of the engine.

The fuel vapor injectors are constructed to discharge fuel vapor to the air inlet port regions of respective combustion regions of the engine or the fuel vapor injectors are constructed to discharge fuel vapor directly to respective combustion regions of the engine.

The fuel vaporizer is sized and constructed to provide fuel vapor to a single combustion region of an engine having multiple combustion regions, the heat-transfer surface of the vaporizer is effectively cup-shaped including a transverse surface opposed to the spray and an outer wall portion surrounding the spray. Embodiments of this feature may have one or more of the following features. The vaporizer has a glow plug centrally disposed with respect to the transverse surface, the glow plug has an axis, the axis being substantially aligned with an axis of the spray. The transverse surface is radially curved or sloped to receive and deflect the spray in a mixing pattern. The transverse surface is a concave surface of a torroidal section. The valve for vapor flow is a spring-loaded valve constructed to be opened by pressure in the pressure chamber. The valve for vapor flow is constructed to be opened and closed by a timing system of the engine.

The fuel vaporizer is dedicated to serve one combustion region of an engine having multiple combustion regions, the liquid fuel injection system being constructed to inject controlled pulses of liquid fuel spray into the volume of the vaporizer, each pulse in a timed relationship with the engine and in amount suitable for a fuel charge for the combustion region. Embodiments of this feature may have one or more of the following features. The flow control is a vapor injection valve constructed for operation in a timed relationship with the engine and a control system is adapted to control the interval between each pulse of liquid spray into the vaporizer volume and actuation of the vapor valve. The fuel vaporizer is constructed to produce diesel fuel vapor. The control system is constructed to maintain the interval between injection of liquid spray into the chamber and injection of diesel vapor to assure pressure in the vapor chamber sufficient to enable injection of diesel injection of diesel vapor directly into the combustion region at commencement of the power phase of the combustion chamber.

Another particular feature is a fuel vaporizer for an internal combustion engine having a combustion region, comprising: a closed pressure chamber defining a volume, a heat-transfer surface associated with the volume and arranged to be heated, and a liquid fuel supply system disposed to emit into the volume, under pressure, an expanding pattern of liquid fuel spray from at least one outlet spaced from the heat-transfer surface, the liquid fuel supply system comprising a fuel injection system constructed to inject the spray in controlled pulses, each pulse synchronized with timing of the engine and in amount suitable for a fuel charge for the combustion region of the engine, the heat-transfer surface being effectively cup-shaped including a transverse surface opposed to the spray and an outer wall portion surrounding the spray, the vaporizer having, effectively, a glow plug that is centrally disposed with respect to the transverse surface, the glow plug having an axis, the axis being substantially aligned with the spray, and a vapor flow control comprising a valve constructed to be opened to deliver fuel vapor for the combustion region of the engine.

Embodiments of this feature may have one or more of the following features.

The valve through which fuel vapor is delivered is spring-loaded and constructed to be opened by pressure in the pressure chamber.

The valve through which fuel vapor is delivered is constructed to be opened and closed by a timing system of the engine. In a preferred form, the vaporizer is associated with a control system adapted to control the interval between each pulse of liquid spray into the volume of the vaporizer and actuation of the valve through which fuel vapor is delivered. The fuel vaporizer is constructed to produce diesel fuel vapor and inject the vapor into the combustion region.

Another particular feature is a fuel vaporizer for an internal combustion engine equipped with an electrical system that comprises a battery and electric source powered by the engine, the fuel vaporizer comprising: a closed chamber; first and second heat-transfer surfaces associated with the chamber and arranged to be heated, at least the second heat-transfer surface being heated by electric power from the electrical system; and a liquid fuel supply system disposed to emit into the chamber, under pressure, at least one expanding pattern of fuel spray of liquid from at least one outlet, the chamber and the liquid fuel supply system being constructed and arranged relative to the first heat-transfer surface to establish between the at least one outlet and the first heat-transfer surface a vaporizing region in which during running conditions, the fuel spray is substantially heated and vaporized, and the chamber and the liquid fuel supply system being constructed and arranged relative to the second heat-transfer surface to enable, under cold conditions, impact of liquid spray directly upon the second heat-transfer surface, the second heat-transfer surface being arranged to be heated rapidly and constructed to vaporize impacting spray to provide fuel vapor for the engine under cold conditions.

Embodiments of this feature may have one or more of the following features.

The liquid fuel supply system is constructed to produce from the at least one outlet a spray pattern distributed about an axis, the first heat-transfer surface being of the form of a surface of revolution surrounding the spray, and the second heat-transfer surface comprising a surface disposed across the axis in opposition to the general direction of progress of the spray.

The fuel vaporizer has its second heat-transfer surface heated by at least one glow plug energized by the electrical system, in a preferred embodiment the heat-transfer surface being defined by a thermally conductive plate and the glow plug is in thermal contact with the plate.

The fuel vaporizer includes a control for energizing the glow plug of the second heat-transfer surface only under cold conditions.

The fuel vaporizer chamber defines a single volume to which both of the heat-transfer surfaces are exposed for vaporizing action.

The fuel vaporizer is constructed to vaporize liquid fuel during running conditions in substantial absence of air.

Another particular feature is a fuel vaporizer for an internal combustion engine that is equipped with an electrical system that comprises a battery and electric source powered by the engine, the fuel vaporizer constructed to vaporize liquid fuel in substantial absence of air during running conditions, the fuel vaporizer comprising: a closed pressure chamber defining a volume; first and second heat-transfer surfaces associated with the volume, each heated by electric power from the electrical system; and a liquid fuel supply system disposed to emit into the volume, under pressure, an expanding pattern of fuel spray of liquid from at least one outlet, the chamber and the liquid fuel supply system being constructed and arranged relative to the first heat-transfer surface to establish between the at least one outlet and the heat-transfer surface a mixing domain in which the fuel spray, as it progresses through the volume from the outlet, is substantially heated and vaporized by mixing with recirculated, heated fuel vapor that previously has moved over and received added heat from the heat-transfer surface, the pressure chamber and the liquid fuel supply system being constructed and arranged relative to the second heat-transfer surface to enable, under cold conditions, impact of liquid spray directly upon the second heat-transfer surface, the second heat-transfer surface being constructed to vaporize impacting spray, the fuel vaporizer associated with a vapor outflow passage which includes a flow control, the fuel vaporizer constructed and arranged to enable flow of pressurized fuel vapor to the engine while positive pressure is maintained within the volume.

Another particular feature is a diesel fuel vaporizer for an internal combustion engine equipped with an electrical system that comprises a battery and electric source powered by the engine, the fuel vaporizer constructed to vaporize liquid diesel fuel, the vaporizer comprising: a closed pressure chamber defining a volume, a heat-transfer surface associated with the volume and heated by electric power from the electrical system, and a liquid fuel supply system disposed to emit into the volume, under pressure, an expanding pattern of diesel fuel spray of liquid from at least one outlet spaced from the heat-transfer surface, the chamber and the liquid fuel supply system being constructed and arranged relative to the heat-transfer surface to establish between the at least one outlet and the heat-transfer surface a mixing domain in which the fuel spray, as it progresses through the volume from the outlet, is substantially heated and vaporized by mixing with recirculated, heated fuel vapor that previously has moved over and received added heat from the heat-transfer surface, the fuel vaporizer associated with a vapor outflow passage which includes a flow control, the fuel vaporizer constructed and arranged to enable flow of pressurized diesel fuel vapor to the engine while maintaining positive pressure within the volume in which vaporization occurs.

Embodiments of this feature may have one or more of the following features.

The diesel fuel vaporizer includes an air inlet constructed and arranged to introduce a limited flow of pressurized air into the volume.

The diesel fuel vaporizer includes a second heat-transfer surface, the pressure chamber and the liquid fuel supply system being constructed and arranged relative to the second heat-transfer surface to enable, under cold conditions, impact of liquid spray directly upon the second heat-transfer surface, the second heat-transfer surface being constructed to vaporize impacting spray to provide fuel vapor for the engine.

Another particular feature is a fuel vaporizer and vapor injector for an internal combustion engine, comprising: a closed pressure chamber defining a volume, a heat-transfer surface associated with the volume and arranged to be heated, and a liquid fuel supply system disposed to emit into the volume, under pressure and in the absence of air, an expanding pattern of liquid fuel spray from at least one outlet spaced from the heat-transfer surface, the liquid fuel supply system comprising a fuel injection system constructed to inject controlled pulses of liquid fuel spray into the volume, each pulse in timed relationship with the engine and in amount suitable as a charge for a combustion region of the engine, the heat-transfer surface including a transverse surface opposed to the spray and an outer wall portion surrounding the spray, the heat-transfer surface associated with a glow plug to heat the spray and produce fuel vapor, the flow control comprising a valve constructed to be opened in a timed relationship with the engine at an interval following the respective pulse of liquid spray to deliver fuel vapor directly to the engine.

Embodiments of this feature may have one or more of the various cup-shape and glow plug features described above with respect to dedicated fuel vaporizers, and may be constructed to vaporize diesel fuel.

Another particular feature is a fuel vaporizer for an internal combustion engine, the engine equipped with an electrical system that comprises a battery and electric source powered by the engine, the fuel vaporizer comprising: a closed pressure chamber defining a volume, at least one heat-transfer surface associated with the volume and arranged to be heated solely by the electrical system of the engine, and a liquid fuel supply system disposed to emit into the volume, under pressure, an expanding pattern of fuel spray of liquid from at least one outlet spaced from the heat-transfer surface, the chamber, the liquid fuel supply system and heating of the heat-transfer surface being cooperatively constructed and arranged to vaporize the fuel to produce fuel vapor under substantial pressure, the fuel vaporizer associated with a vapor outflow passage which includes a flow control, the fuel vaporizer constructed and arranged to enable flow of pressurized fuel vapor to the engine while maintaining substantial super-atmospheric pressure within the volume in which vaporization occurs.

Embodiments of this feature may have one or more of the following features.

The fuel vaporizer is constructed to vaporize liquid fuel in substantial absence of airflow.

The fuel vaporizer is constructed to vaporize liquid fuel in presence of a limited flow of air into the pressure chamber. The air may be injected under pressure in a manner to promote atomization of the spray of liquid.

Another particular feature is a fuel vaporizer having a heat-transfer surface defined by a transversely extending heat-conductive member having a general direction of extent, and at least one electrically energizeable glow plug having its heated portion in intimate thermal contact with the conductive member, the axis of the glow plug being generally perpendicular to the direction of extent of the heat-conductive member.

Embodiments of this feature may have one or more of the following features.

The fuel vaporizer has a vapor-producing heat-transfer surface that comprises the inside surface of a wall member in the form of a surface of revolution, and the transversely extending heat-conductive member comprises an annular member surrounding and in thermal contact with the wall member.

The fuel vaporizer has a transversely extending heat-conductive member which extends transversely to the direction of a spray of fuel from an injector. In one embodiment the member comprises a thermally conductive plate. In another embodiment the transversely extending member defines a bottom portion of a cup-shaped fuel vaporization chamber. In another embodiment the heat-conductive member is shaped to assist in guiding flow into a recirculating pattern of mixing action.

Another particular feature is a glow plug comprising an internal electrically resistive heater in the form of an elongated helical coil of a platinum alloy, an elongated, closed end outer tube of heat resistant metal defining an internal cavity in which the resistive heater coil resides, and a thermally conductive, electrically insulative filler within the tube comprised substantially of fine glass powder, insulating the heater electrically from the tube while forming a thermal conductive path therebetween. In one embodiment an outer end of the resistive heater coil is connected to a terminal member, the terminal member being sealed to outer structure of the glow plug by high temperature pressure seal glass.

The details of selected designs are set forth in the accompanying drawings and the description below. Other features, objects, and advantages will be apparent from the description and drawings, and from the claims.

### DESCRIPTION OF DRAWINGS

FIG. 1 is a cross-sectional diagram of a mixing chamber for vaporization of fuel.

FIG 1A is a partially broken away diagrammatic, perspective view of active parts of a fuel vaporizer.

FIG. 2 is a cross-sectional diagram of an impingement arrangement for vaporization of fuel under cold start conditions.

FIG. 2A is a diagrammatic perspective view of active parts of a fuel vaporizer.

FIG. 3 is a cross-sectional diagram of a vaporizer for delivering an air and fuel vapor mixture to an engine.

FIG. 3A is a cross-sectional diagram of a rotary valve of the vaporizer of FIG. 3.

FIG. 4 is a cross-sectional diagram of a system that includes the vaporizer of FIG. 3 and additional components.

FIG. 5 is a cross-sectional diagram of another vaporizer for delivering an air and fuel vapor mixture to an engine.

FIG. 6 is a cross-sectional diagram of another vaporizer for delivering an air and fuel vapor mixture to an engine.

FIG. 7 is a circuit diagram of the pulse controller of the system of FIG. 4.

FIG. 7A is a diagram of a pulse train generated by the pulse controller of FIG. 4.

FIG. 8 is a cross-sectional diagram of a vaporizer for delivering fuel vapor to a fuel vapor-injected engine.

FIG. 8A is a cross-sectional diagram of a variant of the vaporizer of FIG. 8.

FIG. 8B is a view similar to FIG. 8A of another embodiment while FIGS. 8C and 8D are respectively plan views of the top and bottom plates of the vaporization chamber.

FIG. 9 is a cross-sectional diagram of a system that includes the vaporizer of FIG. 8 and additional components.

FIG. 9A is a view similar to FIG. 9, of a system that includes additional features.

FIGS. 9B and 9C are diagrammatic end and plan views respectively of a V-8 engine employing a fuel vaporizer, fuel vapor injection, and cold start liquid fuel injection.

FIG. 9D is a diagrammatic cross-sectional view of a fuel vapor injector while FIG. 9E is a similar view of a cold start liquid fuel injector.

FIG. 9F is a partial cross-section diagrammatically depicting the relationship of a fuel vapor injector to its supply rail.

FIGS. 9G-1 through 9G-4 depict respectively the strokes of a four-stroke gasoline engine employing a fuel vapor injector at its air inlet port.

FIG. 10 is a cross-sectional diagram of a vaporizer for delivering diesel vapor to a diesel engine.

FIG. 10A is a cross-sectional diagram of another diesel vaporizer.

FIG. 11 and 11A are side cross-section and horizontal cross-sections of a vaporizer combining impingement and mixing actions in producing fuel vapor.

FIGS. 12 and 12A, and FIGS. 13 and 13A are views similar to those of FIGS. 11 and 11A of other embodiments.

FIG. 14 is a diagrammatic cross-section, similar to FIG. 9D, of a fuel vapor injector that incorporates its own fuel vaporizer.

FIG. 15 is a diagram depicting injection of fuel vapor into the air inlet port of a cylinder of an engine.

FIG. 16 is a view similar to FIG. 14 of another embodiment of a combined fuel vaporizer and vapor injector.

FIG. 17 is a diagram depicting injection of fuel vapor directly into a cylinder of an engine.

FIG. 18 is a schematic diagram of the fuel supply arrangement for a diesel engine employing the device of FIG. 16.

FIGS. 19A through 19D illustrate the four strokes of a conventional diesel engine.

FIG. 20 is a magnified side-view of a glow plug useful in the embodiments shown, while FIG. 21 is a cross-sectional view of greater magnification of the tube, insulation and heating element of the glow plug, and FIG. 22 is a cross-sectional view of the connection of the stem of the glow plug to the mounting body.

Like reference symbols in the various drawings indicate like elements.

### DETAILED DESCRIPTION

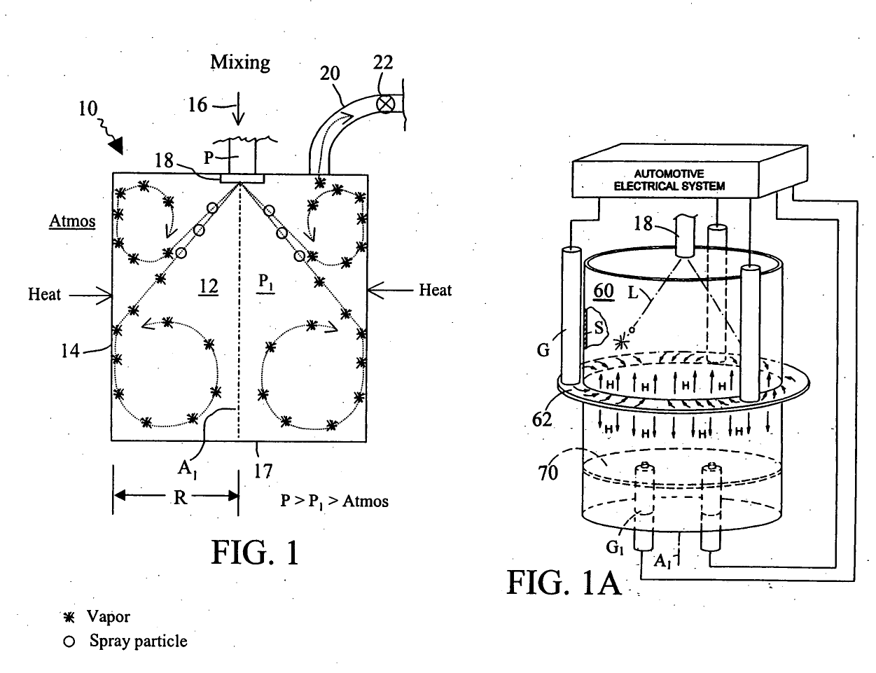

Referring to FIG. 1, a vaporization chamber 10 vaporizes liquid fuel in a volume 12. This vaporization is a process whereby liquid fuel particles are converted to a gas state in which very finely divided residual particles may also be suspended. For instance the lighter components of liquid fuel particles may be totally transformed to gas while the heavier components are partially transformed to gas with residual exceedingly small particles as in a fine fog, that present a large aggregate surface area that enables rapid heating and combustion in the engine.

A closed pressure chamber that includes cylindrical wall 14 and end walls 15, 17, defines the volume 12. The cylindrical wall 14 is heated by an external heat source, as indicated by the arrows. The liquid fuel 16 arrives at the chamber 10 from a pressurized source and enters the volume 12 in pulses through an injector 18. The injector 18 sprays the liquid fuel into the volume 12 at pressure through one or a set of small holes. The injector 18 breaks up the liquid fuel into spray, initially forming a cone or other desired spray pattern about an axis Aₗ. The radius R of chamber 10 is sufficient to define an open space in which the spray traveling through the volume 12 is subjected to an energetic mixing and heating action by contact with recirculated, heated fuel vapor that previously has moved over wall 14 and received added heat. The fuel vapor fills exit channel 20. An outlet system, diagrammatically indicated at 22, controls the exiting flow rate of the fuel vapor. The fuel flow rate through the injector 18, the heating and vaporization action, and the flow-restrictive effect of the outlet system 22 determines the pressure of the vapor inside the volume 12. Under normal operating conditions, injection pressure P of the liquid fuel entering the injector 18 is greater than pressure P₁ of the fuel vapor inside the volume 12, while the pressure P₁is maintained substantially above atmospheric pressure.

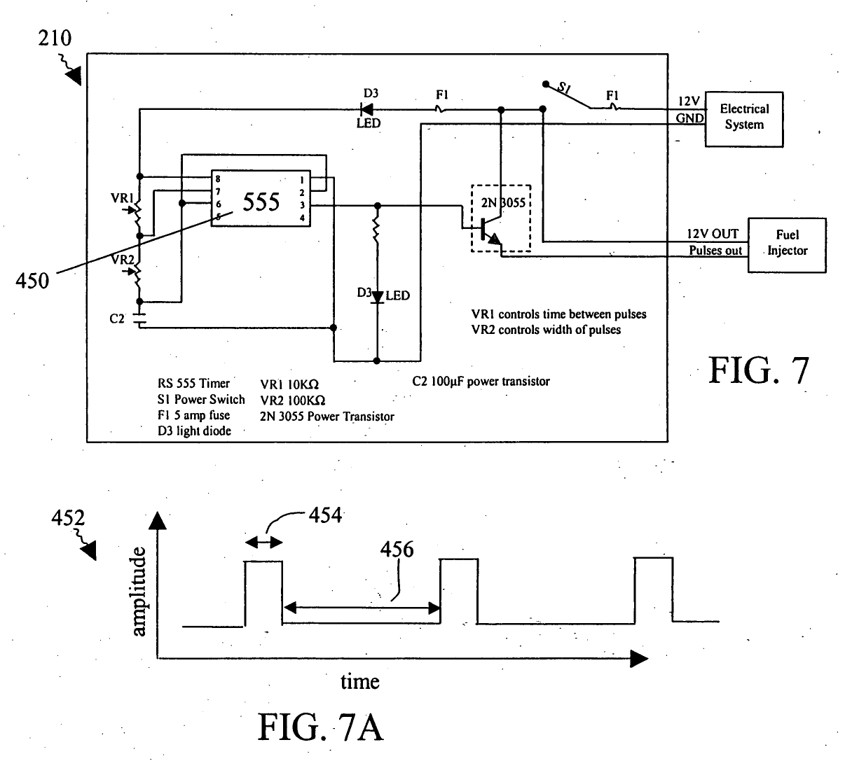

In manner described later, see FIGS. 7 and 7A, flow of fuel is produced in pulses of pulse width and frequency to meet the fuel demand, advantageously with pulse width in excess of one second.

In the system shown, during normal operating conditions there is substantial absence of air in the volume 12.

In one example, radius R of the chamber is in excess of 1 inch but less than 3 inches, for instance 1¼ inch, while the height H of the chamber is in excess of 3 inches but less than 8 inches, for instance 5 inches.

Details of an example of a vaporizer unit constructed to operate according to the principles of FIG. 1, are shown in FIG. 1A. A cylindrical wall member 60 defines an inner, cylindrical heat-transfer surface S that, together with end walls, bounds a region into which liquid spray L is emitted. Wall member 60 is formed of a continuous sheet of aluminum, of 1/16 inch thickness. The cylinder 60, for instance, may have a diameter of 2½ inch. On the exterior of wall member 60 is a thermally conductive annular heat distribution member 62 in thermal contact with the wall member 60. An array of electric glow plugs G is associated with the annular heat distribution member 62. The heat distribution member is constructed and arranged to provide both radial and circumferential heat-conductivity paths H, enabling the glow plugs G to efficiently heat strategic regions of the wall member. Surface S of the heated wall member in turn heats vapor that passes over that surface. In the embodiment shown, annular heat distribution member 62 is of flat disk form, of aluminum plate of ⅛ inch thickness. The plane of the plate 62 lies perpendicular to the axis A₁ of the cylinder. The plate 62 is in thermal contact with the exterior of cylindrical wall member 60 at a location spaced from the ends of member 60. This thermal contact is accomplished for instance by press fit or welding. At selected locations about the annular heat distribution member 62, electrically powered glow plugs G are disposed in thermal contact with distribution member 62. The axis of each glow plug G is perpendicular to the plane of the plate 62 and the most heated portion of each glow plug G is disposed in a depression or hole formed in the plate 62, in thermal contact with the substance of the plate 62 as by a press fit. In the example shown, there are three glow plugs G equally spaced about the periphery of wall member 60.

The glow plugs G are connected to the electrical system of an automotive engine, as shown. When the vaporizer unit is constructed for running conditions of the engine, the glow plugs may be selected each to draw 5 amps from a 12 volt electrical system. The glow plugs are intended to be cycled on and off, simultaneously or one at a time, in response to an appropriate control system. The control system may employ thermal sensors to monitor the thermal status, and may be supplemented by a pressure control system, to monitor the pressure within the vaporizer. By such an arrangement, the glow plugs are energized to meet the vapor demand. The glow plugs G may be energized simultaneously with activation of the cold start system or energization may follow activation and turn off of the cold-start system. The initial phase of warming wall member 60 may continue until the unit reaches operational conditions. Then, in a second phase, the glow plugs may be energized from time to time in accordance with vapor demand. In some examples the set of glow plugs G may be energized simultaneously or they may be energized sequentially about the array to reduce the instantaneous power demand on the electrical system to one glow plug at a time.

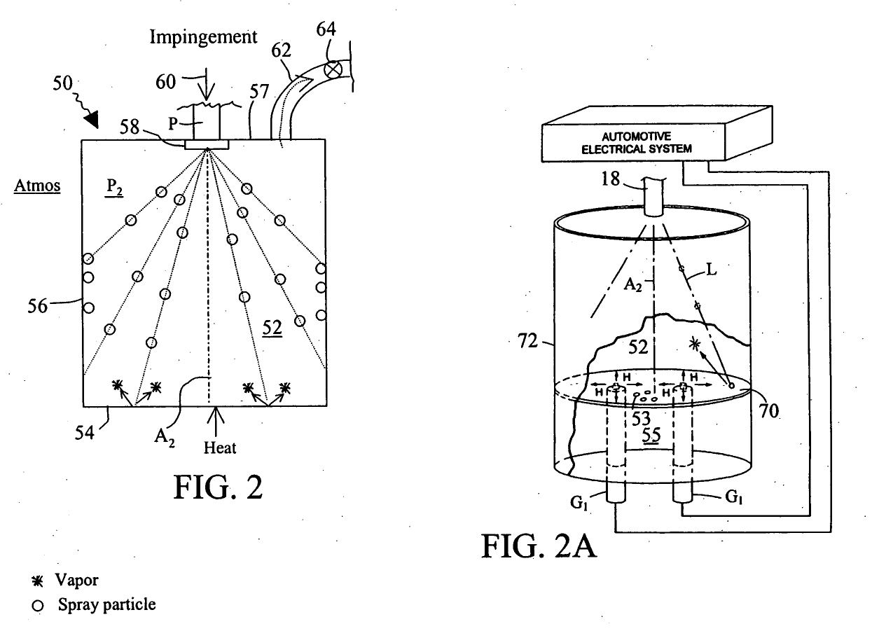

A feature of this construction is that the thermal mass of thin wall member enables relatively quick warm up while enabling efficient electrical operation during running condition. Further features that may be included are shown in broken lines at the bottom of FIG. 1A and will be described following the description of FIGS. 2 and 2A.

A construction similar to that of FIG. 1A, that is suitable for mass production, may be formed as an integral casting, e.g. of aluminum, into which a heating device equivalent to glow plugs is incorporated. Details of the construction may be adapted to accommodate differences in thermal expansion that may occur, which may depend upon variations in time and location of the heating. For example, flexible regions serving as expansion joints may be provided. For higher temperature operation, material suitable for higher temperature may be employed, for instance high temperature stainless steel alloy such as Inconel 617.

Referring to FIG. 2, another vaporization system transfers heat from a rapidly heated transverse plate 54 located within pressure chamber 50. Cylindrical wall 56, end walls 57 and end plate 54 enclose vapor volume 52. Injector 58 that sprays liquid fuel through one or a set of small holes injects pressurized liquid fuel. The spray from the injector 58 proceeds, for instance, in a cone symmetric about an axis A₂. Heated transverse plate 54 extends across the axis A₂, in the case shown being perpendicular to axis A₂.

In the example, using the construction illustrated in FIG. 2, the plate is positioned to serve during cold start conditions as an impact plate upon which liquid fuel impacts, wetting the plate 54. In this case, the components of the vaporizer unit are chosen such that vaporization occurs directly at plate 54 during cold start. Under cold start conditions the position of plate 54 relative to injector 58 enables the plate to intercept central portions of the liquid spray. The liquid fuel is vaporized by the rapidly heated plate 54, the vapor filling volume 52 and exit channel 62. An outlet system, diagrammatically indicated at 64, controls the exiting flow rate of the fuel vapor such that the pressure of vapor inside the volume 52 is P₂. Liquid fuel is supplied in one or more pulses to the injector. The source of liquid fuel 60 keeps the pressure P above P₂ at times of spray injection to produce the flow through the injector.

For a vaporizer supplying fuel vapor to an automotive engine, advantageously the volume of the chamber 52 for cold start may also serve as the vaporizing space 12 of chamber 10 of FIG. 1 for running conditions. In other examples, the vaporization system includes separate volumes 12 and 52, in which the vaporization chamber 50 is used during cold start conditions while the vaporization chamber 10 is used for warm running conditions, in which case the volumes can communicate so that vapor produced in the cold start volume fills the running condition volume, to assist in initiating running conditions, and the cold start volume may serve for additional vapor storage during running conditions.

Details of an example of a vaporizer unit constructed to operate according to the principles of FIG. 2 are shown in FIG. 2A. A transverse conductive heat distribution member 70 having a generally continuous surface is disposed within the bounds of an enclosing wall member 72. The wall member may be the cylindrical wall 60 of FIG. 1A, or a wall member of different construction or configuration. In the embodiment shown, heat distribution member 70 is a flat aluminum plate of 1/16 inch thickness of circular configuration, the plane of the plate lying perpendicular to the axis A₂ of the cylindrical wall. Plate 70 has its peripheral region in thermal contact (i.e. with thermal conduction continuity) with the interior of the wall member as by press fit, welds, or otherwise. Plate 70 is spaced from the ends of the wall member to define an additional vapor volume 55 that communicates with volume 52 via flow passages such as holes 53 provided in plate 70.

At selected locations inwardly from the periphery of the transverse heat distribution plate 70, electrically powered glow plugs G₁ are disposed perpendicular to and in thermal contact with the plate 70. For instance, the heated portion of each glow plug G₁ is press fit within a depression or hole formed in the plate 70. In the example shown, there are two glow plugs G₁ spaced equally from each other and from the periphery of transverse member 70. In this example, the body of the glow plugs extends upward from the bottom, through the auxiliary vapor space 55, the side surfaces of the glow plug bodies that receive heat from the glow plug resistive element being exposed to vapor in space 55.

The glow plugs G₁ are connected to the electrical system of an automotive engine and may be selected each to draw 5 amps from a 12 volt electrical system. When such a unit is constructed for cold start of the engine, the member 70 is located relative to liquid spray injector 18 to receive liquid spray L upon its surface during cold start conditions. For use in start-up mode, the two glow plugs G₁ may be energized upon activating the ignition switch of the engine, and then de-energized quickly, e.g. within 3 to 5 seconds, as the vaporizer reaches an appropriate vapor-filled condition. Control of injection and heating may be accomplished with an appropriate control system. The vaporizer may employ thermal sensors to monitor the thermal status and a pressure sensor to monitor the pressure within the vaporizer. This vaporizer arrangement enables the cold start vaporizer action of the embodiment of FIG. 2 to begin. The active portion of this construction has low thermal mass, enabling rapid, electrically efficient start-up. After start-up, the glow plugs in transverse member 40 may be de-energized to hand off the vaporizing action to another system, for instance the system of FIG. 1A. The heating of the surrounding member may thus initially be accomplished by the glow plugs G₁ of the transverse wall member, and after hand-off by the glow plugs G heating the annular member of FIG. 1A. In another system, in which the electrical system is sufficiently robust, both sets of glow plugs G and G₁ are energized at start-up, with the cylindrical wall being rapidly heated and serving as an additional liquid impact surface at start-up, for surface evaporation.

With further reference to FIG. 1A, in some cases, after its initial use in cold start, the glow plugs G₁ of the transverse member 40 may be periodically heated, e.g. in sequence with the glow plugs G of the embodiment of FIG. 1A, so that the surface of transverse member 70 may participate in the vaporizing action described with respect to FIG. 1. Even with the glow plugs in member 70 de-energized, the surface of member 70, via its thermal contact with the cylindrical wall member, may be adapted to play a role in heating vapors or maintaining their heated condition.

A construction similar to the embodiment of FIG. 2A, suitable for production, may be formed of as a unit, for instance an integral metal casting, e.g. of aluminum, into which a device equivalent to glow plugs is incorporated. In another case, a unit combining both the annular heat distribution feature of FIG. 1A and the transverse member feature of FIG. 2A may be combined in a single unit such as on aluminum casting.

In a variation, the transverse member 70 of FIG. 2A may be adapted to provide the principal vaporization action according to the principles of both FIG. 2 for cold start, and FIG. 1 for running operations.

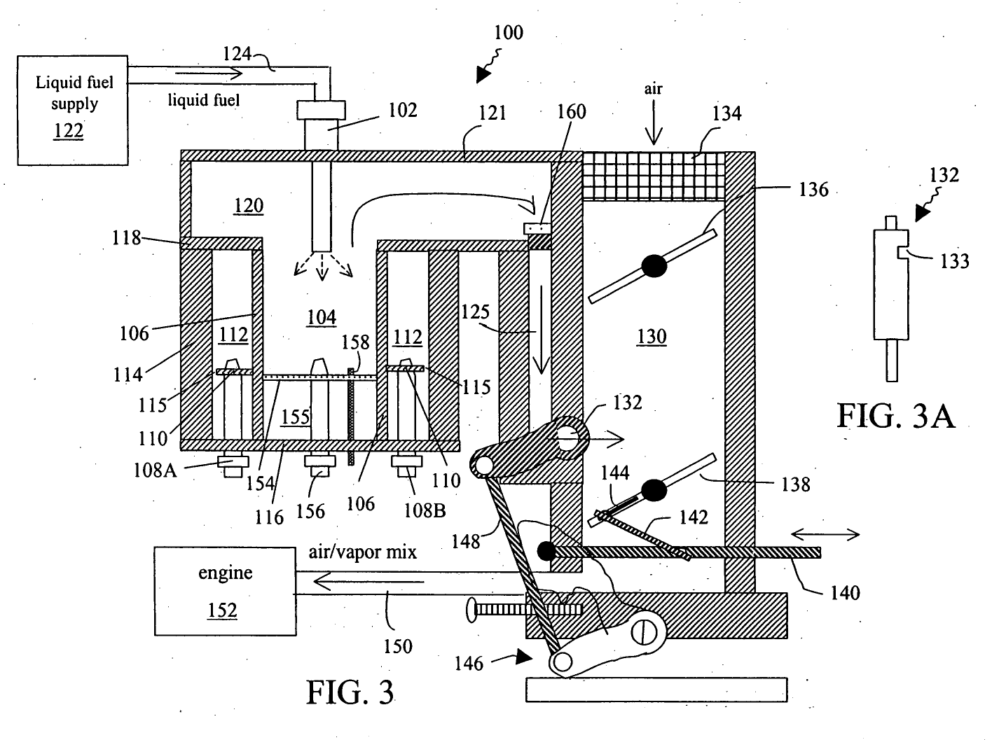

Referring to FIG. 3, a vaporizer 100 includes essential features of both chambers 10 and 50, of FIGS. 1 and 2. In addition to the vaporizing volume 104, the vaporizer 100 includes vapor storage volume 120 that communicates with a delivery passage 125.

The vaporizer 100 replaces a carburetor of a gasoline engine by supplying gasoline fuel vapor to combustion air for the engine. The engine includes an electrical system that includes a battery associated with a generator or alternator, the system capable of supplying electrical power at startup and during running conditions. The vaporizer 100 can be referred to as a throttle body fuel system or single point or central fuel system. The vaporizer 100 can be constructed to be a bolt-on replacement for the carburetor, so a conventional engine design normally using a carburetor does not require significant modification to receive the vaporizer 100.

The vaporizer 100 includes a liquid fuel injector 102 that sprays the liquid into the volume 104 at a pressure through one or a set of small holes. In one example, the liquid fuel injector 102 has a single hole orifice of about 0.001 inch in diameter. The injector 102 is electronically controllable such that an electrical “ON” signal opens the liquid supply passage while an electrical “OFF” signal shuts the passage. The spray from the injector 102 forms a cone of spray about an axis. In some examples, the cone of spray forms about a ninety degree apex angle. The vaporization volume 104, during warm running conditions, contains recirculating fuel vapor that is heated as it reaches and flows over the surface of cylindrical wall 106 in a turbulently recirculating flow. Similarly to the process illustrated in FIG. 1, the vaporizer 100 vaporizes the spray of liquid fuel from the injector 102 by energetic turbulent mixing of the high velocity liquid fuel spray with recirculated, heated fuel vapor that previously has moved over and received added heat from the wall 106. During warm running conditions, the temperature in the volume 104 is maintained at a temperature corresponding to the vaporization temperature of the fuel under operating conditions. The particular temperature depends upon the vaporization temperature of a volatile fraction that makes up the fuel selected as well as the particular positive pressure range selected for operation of the vaporizing volume. In one example, the temperature in the volume 104 may be maintained at 168° F.

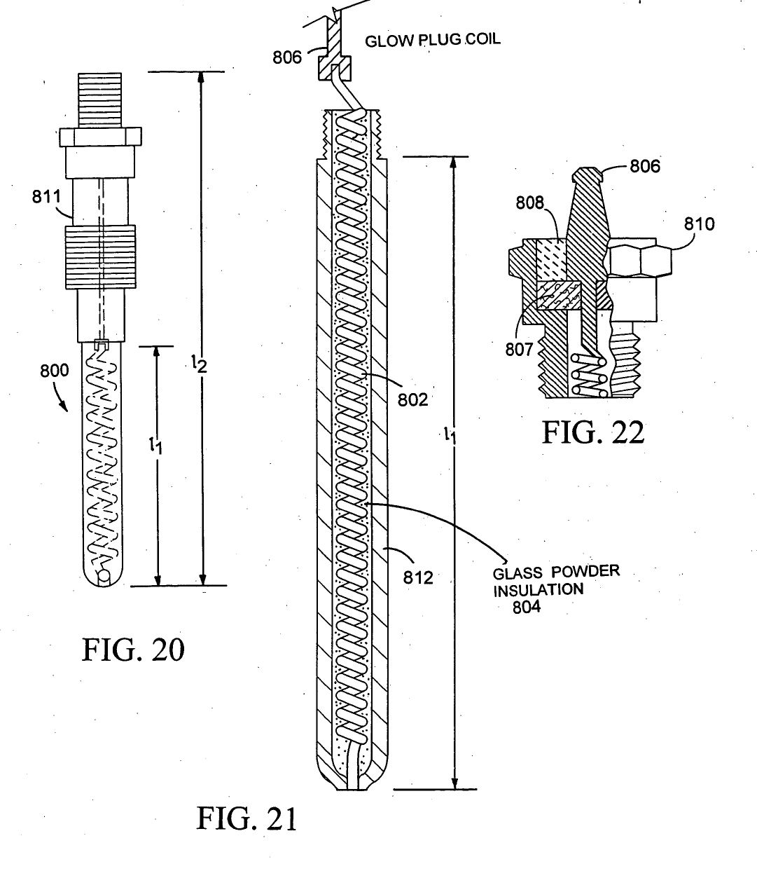

The cylindrical wall 106 is heated, through heat-transfer, by glow plugs 108A and 108B, powered by the electrical system of the engine. There may be for instance three glow plugs symmetrically located about the cylinder. Glow plugs operable in this application, manufactured by Bosch are available from Mercedes-Benz USA, LLC of Montvale, N.J. as part number 001.159.2101. These glow plugs can readily achieve temperatures of about 300° F. at their tips, and see FIGS. 20-22, below. In other examples (not shown), additional glow plugs may be used to heat the cylindrical wall 106. The glow plugs 108A, 108B are located in an annular space 112 defined on the inside by wall 106 and on the outside by spaced-apart cylindrical wall 114. The glow plugs 108A, 108B transfer thermal energy to the wall 518 using an annular, thermally conductive metal ring 110, with which there is good thermal conduct, e.g. by press-fit. An insulating space 115 is produced between the outer periphery of annular ring 110 and the surrounding housing to reduce heat loss to the exterior.

The cylindrical walls 106, 114 rest on a bottom plate 116 and a top plate 118 encloses the space. The central volume 104 communicates with storage volume 120 through the top plate 118 via a circular hole, and with vapor storage space 155 below transverse plate 154. The parts 106, 114, 116, 118 and 154 are made of thermally conductive metal, e.g. of aluminum. The plates 116, 118 enclose the annular space 112 by sealing against the cylindrical walls 106, 114. For example, sealing is by silicone rubber O-rings or by suitable gaskets. In an example, the cylindrical wall 106 is ⅛ inch thick while the central volume 104 is 2¼ inch in diameter. The storage volume 120 is defined between the plate 118 and an additional top plate 121. The top plate 121 seals the storage volume 120 e.g. by a silicone rubber o-ring or a suitable gasket.

As fuel vapor is produced in volume 104, it fills the volume 120. Fuel liquid from fuel supply 122 is supplied under elevated pressure from an electric fuel pump via fuel line 124 to the injector 102. During warm running conditions, for liquid fuel injection, the pressure in the volume 104 is lower than in the fuel line 124, but higher than atmospheric pressure. In some examples, the liquid in the fuel line 124 is at a pressure between about 60 to 100 pounds per square inch above atmospheric, i.e., gauge pressure (psig), while pressure of the vapor in the volume 104 is between about 30 and 80 psig at times of injection, with a substantial pressure differential between the pressures at times of injection. For example, the liquid in the fuel line 124 is at 88 psig and the pressure of the vapor in the volume 104 is 70 psig.

Generally, for use with a carburetor system, it is preferred that the pressure in the chamber be maintained between about 65 and 75 psig and in a fuel injection system between about 40 and 50 psig, with the pressure of the liquid fuel being greater than the pressure in the chamber, preferably greater by at least 5 psi, in some cases greater by 10 psi, 15 psi, or more.

The fuel vapor moves from volume 120 through a flow restrictor 160 to a vapor channel 125. The flow restrictor 160 has one or more holes of about 1/16 inch in diameter to constrict the flow of vapor and hold the pressure in the volume 120. It preferably has an adjustment feature. The purpose of the flow restrictor 160 is to limit vapor flow such that pressure is maintained in the pressure chamber 104, 120 even at “full throttle” so as to preserve proper operation of the vaporizer 100. The fuel vapor moves from the vapor channel 125 to an air intake passage 130, which may be shaped as a venturi passage in the usual way (not shown), with the outlet to the air passage located at the low pressure region of the venturi passage.

The flow rate of fuel vapor into an air/vapor mixing region of the air intake passage 130 is further controlled by a rotary valve 132, formed by a rotary central member having a flow slot 133, FIG. 3A. Air into the air intake passage 130 passes through an air filter 134, while airflow is controlled by a butterfly valve 136. An additional butterfly valve 138 controls the flow of the air/vapor mixture from the air intake chamber 130. The rotary movements of the butterfly valves and the rotary valve 132 are produced by axial movement of an accelerator rod 140 and appropriate linkage diagrammatically suggested in FIG. 3. Adjustment features are provided in this linkage.

Air/vapor mix exiting from the air intake passage 130 enters an air intake manifold of engine 152 via passage 150.

During startup of the engine 152, the vaporizer 100 is typically cold so that there is no preexisting warm fuel vapor in volume 104. During startup, plate 154, to serve as an impact plate, is rapidly heated and used to vaporize liquid spray from the injector 102. This follows the techniques described with respect to vaporization chamber 50 (FIG. 2). The plate 154 is thermally conductive metal, preferably aluminum, and of low thermal mass. In one example, the plate 154 is a 1/16 inch thick with 1/32 inch holes through the thickness of the plate 154. In other examples, plate 154 can be ⅛ inch thick. The holes enable vapor or fluid to pass through the plate 154. A volume 155 below the plate 154, adds to the vapor storage capacity of the system. A glow plug 156, powered by the electrical system of the engine, extends upwardly from the bottom of the chamber, through space 155, to heat the plate 154. A heated length of the glow plug body, adjacent to the plug tip, serves as a heat-transfer surface in space 155, its heated length, heated by the glow plug, providing heat to that region. The glow plug 156 is turned on during the cold startup period and then turned off by the control circuit. In other examples, one or more additional glow plugs can be used to heat plate 154 for vaporizing impacting liquid, or to otherwise form a surface for vaporizing the fuel.

For sensing temperature within the vaporizer, in this example a thermocouple 158 measures the temperature of plate 154. During running conditions, with glow plug 156 turned off, a controller (not shown) uses feedback from the thermocouple 158 to control the glow plugs 108A, 108B to maintain a specific temperature within design range in the volume 104. The controller may use proportional, derivative, and integral linear control rules to maintain the temperature in the volume 104. Other known temperature control systems may be employed.

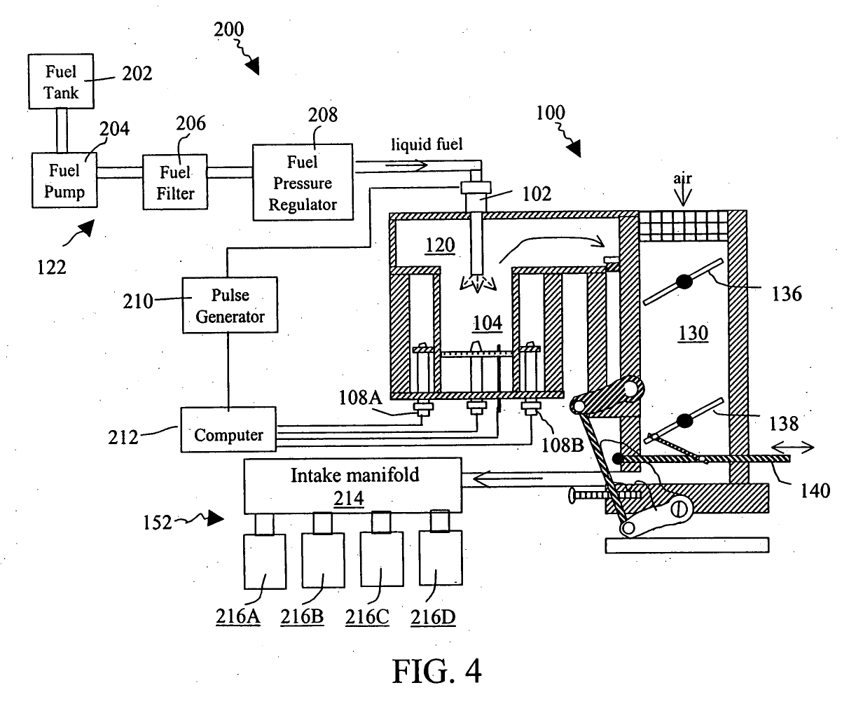

Referring to FIG. 4, a vaporization system 200 includes the vaporizer 100 of FIG. 3. The liquid fuel supply 122 includes fuel tank 202, electric fuel pump 204, fuel filter 206, and fuel pressure regulator 208. Liquid fuel from the fuel tank 202 is pumped by fuel pump 204 through fuel filter 206 and through fuel pressure regulator 208 to arrive at the injector 102 under pressure. The vaporization system 200 also includes a pulse generator 210 capable of generating pulses to turn the injector 102 off and on. A computer 212 controls the frequency and width of pulses generated by the pulse generator 210. The frequency and width of the pulses relates to the desired power demands on the engine 152. The computer 212 also receives feedback from thermocouple 158 to control activation of glow plugs 108A, 108B according to appropriately established control rules during running conditions. The engine 152 includes an intake manifold 214 that supplies the air/fuel vapor mixture to cylinders 216A, 216B, 216C, and 216D. In other examples, the engine 152 of course may have a different number of cylinders and other configurations.

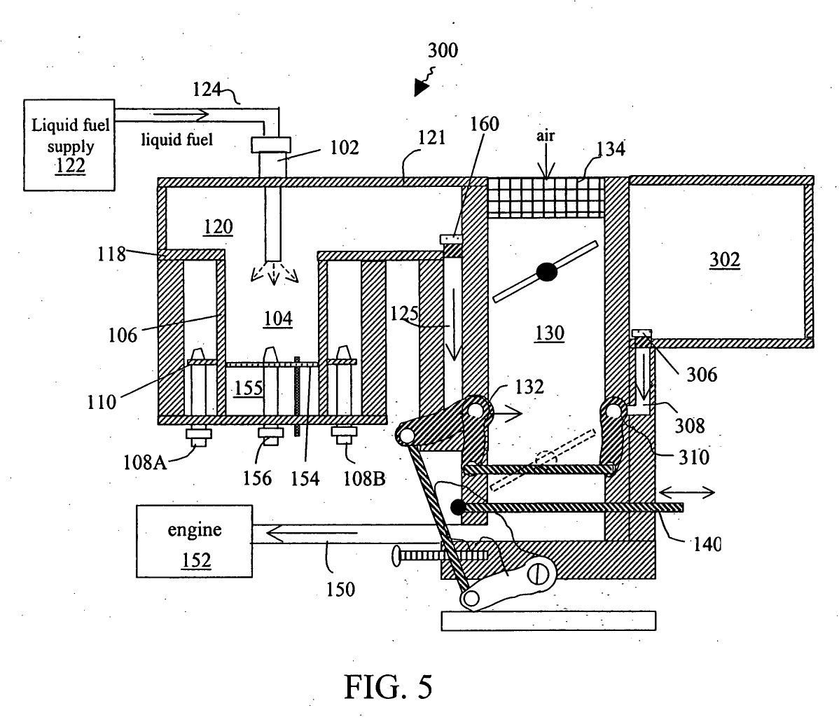

Referring to FIG. 5, a vaporizer 300 includes many features of the vaporizer 100 including the thermally conductive plate 154 extending across the central axis of the wall 106, which is in thermal contact with the wall 106. The vaporizer 300 also includes a vapor storage volume 302. The vapor storage volume 302 is connected to the volume 120 by an open passage (not shown). During cold start conditions, the vaporizer 300 operates in a similar fashion to that of the vaporizer 100, using the glow plug 156 to heat the plate 154. During warm running conditions, the vaporizer 300 operates in a similar fashion to that of the vaporizer 100, using the glow plugs 108A, 108B for heating, during which the plate 154 may be heated to assist in heating fuel vapor that recirculates to vaporize the injected fuel spray. The vaporized fuel flows from the volume 120 to the vapor storage volume 302. The vapor storage volume 302 provides additional fuel vapor for meeting fuel demands of the engine. The vaporizer 300 also includes a flow restrictor 306, a vapor channel 308 and a rotary valve 310. The flow restrictor is similar to restrictor 160 with one or more 1/16 inch holes to constrict vapor flow and maintain vapor pressure in the volume 302. As the vapor fills the vapor storage volume 302, the vapor passes through the restrictor 306 to fill the vapor channel 308. Vapor is released into the air intake passage 130 when the rotary valve 310 opens. The rotary valve 310 is mechanically coupled to the rotary valve 132 such that the valves 132, 310 open the same amount in response to actuation of the accelerator rod 140 (described previously with respect to FIG. 3).

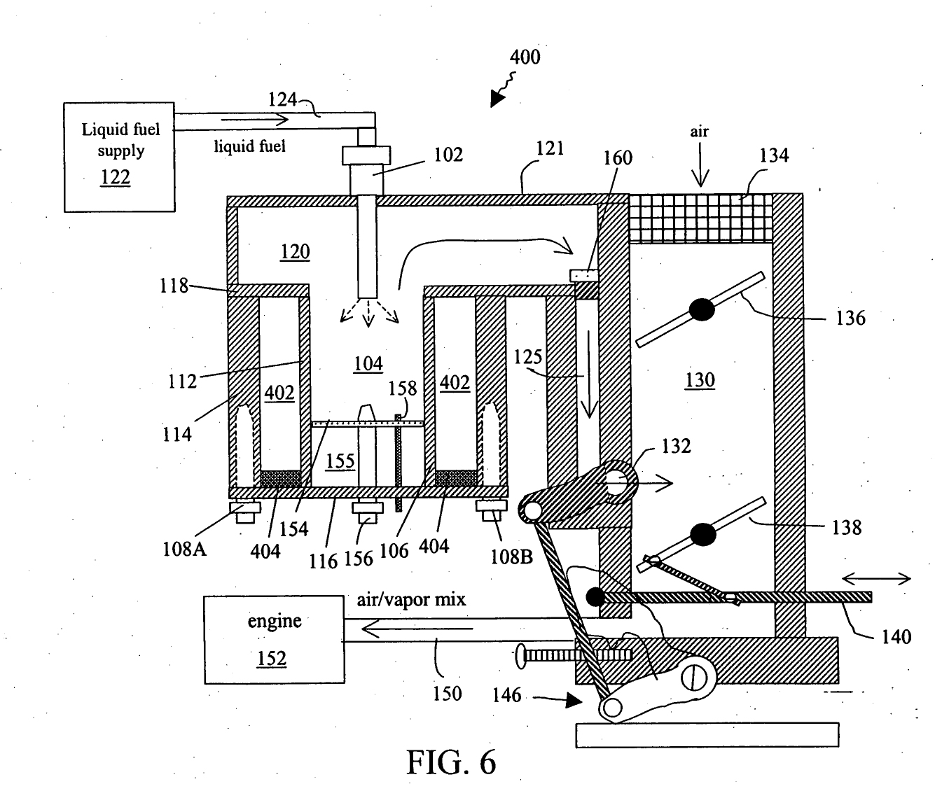

Referring to FIG. 6, a vaporizer 400 is similar to the vaporizer chamber 100 (FIG. 3) except that the glow plugs 108A, 108B heat the volume 104 via a different heat-transfer path. For the vaporizer 400, the glow plugs 108A, 108B are press fitted in holes in the cylindrical wall 114. An annular volume 402, tightly and permanently sealed, surrounds the cylindrical wall 112. The volume 402 contains an amount of thermally conductive metal 404 that may be liquid under operating conditions. It is distributed continuously in annular form around the floor of the volume 402. It is in thermal contact with the corresponding outer portion of wall 112. In some examples, the metal 404 can be heated to about 300° F. In some of these examples, the thermally conductive metal 404 is sodium. Heat is transferred from the glow plugs 108A, 108B to the thermally conductive metal wall 114, thence to the thermally conductive metal 404 and to the thermally conductive wall 112. It is to be noted that the constant temperature of metal in changing from solid to liquid and vice versa introduces a heat sink effect that enables uniform temperature to be maintained around the chamber despite introduction of heat at spaced-apart point locations and despite the glow plugs cycling on and off during operation of the engine. In similar fashion a liquid heat-transfer medium may be provided in accordance with heat pipe principles. At the desired temperature for the fuel vapor-producing heat-transfer surface, within the pressure range for which this heat-transfer unit is designed, this liquid undergoes phase change to gas fuel which fills the heat-transfer volume and heats the walls which define the fuel vapor-producing heat-transfer surface.

Referring to FIG. 7, one example of the pulse generator 210 shown in FIG. 4 uses a timer chip 450 that is available as LM555 from Fairchild Semiconductor Corporation of South Portland, Me. In one example, the pulse generator 210 uses two variable resistors, VR1, VR2 to determine frequency and width of pulses from the pulse controller 210. Referring to FIG. 7A, a pulse train 452 has pulse width 454 and time 456 between pulses. Changing the resistance of VR1 modifies the pulse width 454 while changing the resistance of VR2 modifies the time 456 between pulses. Suitable arrangements of the pulse generator 210 can allow for the pulse width 454 to have a range of 0 to 8 seconds and the time 456 between pulses to have a range of 0 to 60 seconds. The variable resistors VR1, VR2 can be controlled for demonstration by hand using simple hand knobs. In production systems, the pulse generator 210 may be controlled by a computer that is responsive to power demands and running conditions of the particular engine selected.

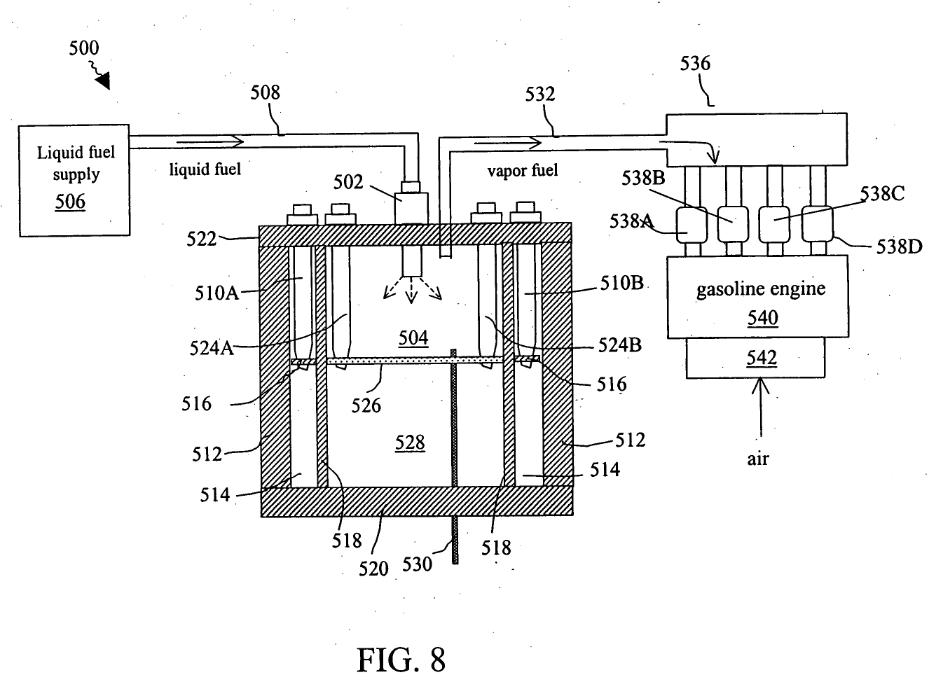

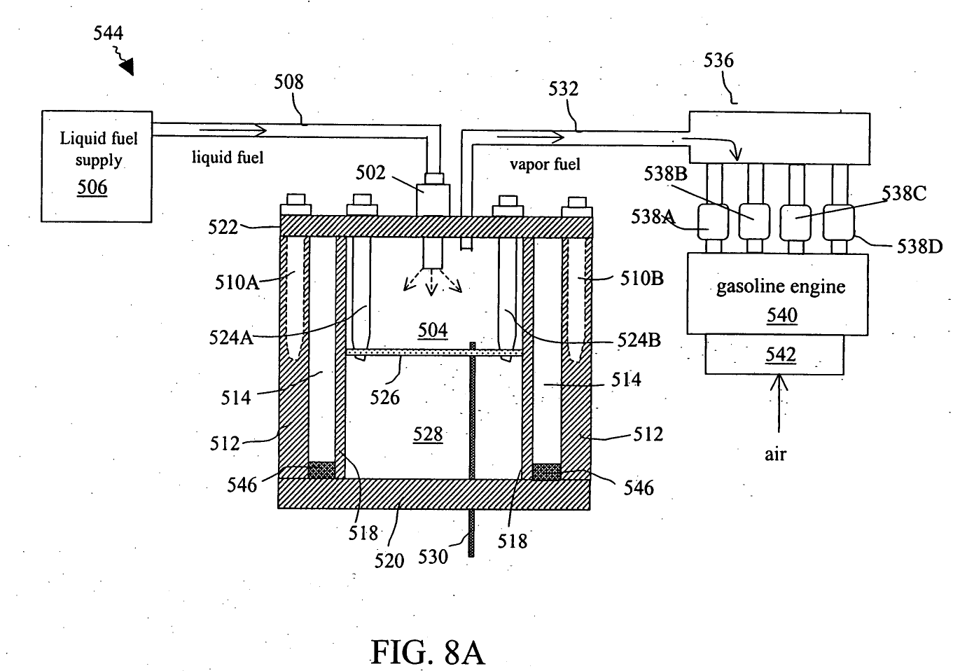

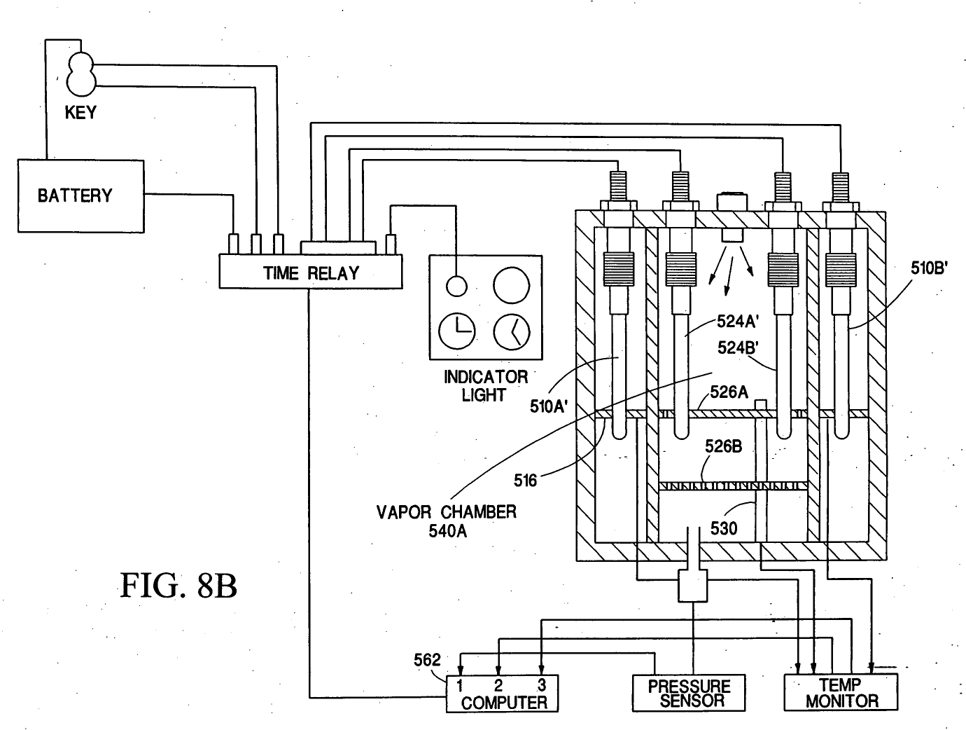

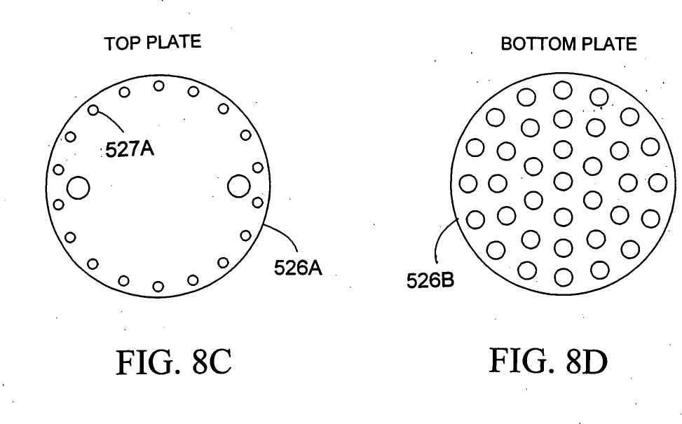

Referring to FIG. 8, a vaporizer 500 uses many elements similar to those of vaporizer 100 to deliver fuel vapor to a fuel injected engine 540 rather than to an engine normally utilizing a carburetor. The fuel injected engine system includes an electrical system capable of supplying electrical power at startup and during running conditions. The vaporizer 500 includes an injector 502 that sprays liquid fuel into the volume 504 at a pressure through one or a set of small holes. In one example, the liquid fuel injector 502 has a single hole orifice of about 0.001 inch in diameter. The injector 502 is electronically controllable such that an electrical “ON” signal opens the injector while an electrical “OFF” signal shuts it. The spray from the injector 502 forms a cone about an axis. The vaporization volume 504, during warm running conditions, contains turbulently recirculating fuel vapor that is heated by heat from a cylindrical wall 518. Similar to the process illustrated in FIG. 1, the vaporizer 500 vaporizes spray of liquid fuel from the injector 502 by vigorous, turbulent mixing of the liquid spray with recirculated, heated fuel vapor that previously has moved over and received added heat from the wall 518. During warm running conditions, the temperature in the volume 504 is maintained at vaporization temperature.

The cylindrical wall 518, axi-symmetric with the fuel vapor spray from the injector 502, is heated, through heat-transfer, by glow plugs 510A and 510B. The glow plugs 510A and 510B are powered by the electrical system of the engine system. Glow plugs operable for this application, by Bosch, are available from Mercedes-Benz USA, LLC of Montvale, N.J. as part number 001.159.2101, and see FIGS. 20-22. In other examples (not shown), additional glow plugs may be used to heat the cylindrical wall 518. The glow plugs 510A, 510B are located in an annular space 514 that extends around the volume 504 and transfer thermal energy to the wall 518 via an annular, thermally conductive metal ring 516 that is press-fit about cylindrical member 518. A cylindrical wall 512 surrounds the annular space 514. The cylindrical walls 518, 512 rest on a bottom plate 520 and a top plate 522 encloses the structure. Sealing rings between the plates 520, 522 and the cylindrical members 512, 518 enable the pressure in the volume 504 to be maintained. The volume 504 is 2¼ inch in diameter. The parts 518, 512, 520, and 522 are made of thermally conductive metal, preferably aluminum. In one example, the cylindrical wall 518 is ⅛ inch thick.

A liquid fuel supply 506 supplies liquid fuel under pressure from an electric fuel pump via fuel line 508 to the injector 502. The pressure P of the liquid fuel in the fuel line 508 is higher than atmospheric pressure. During warm running conditions, the pressure P in the volume 504 is also higher than atmospheric pressure but lower than in the fuel line 508. In some examples, the liquid in the fuel line 508 is at a pressure within the range of about 60 to 100 pounds per square inch above atmospheric (psig) while pressure of the vapor in the volume 504 is between about 40 to 50 psig.

During startup of the engine 540, the vaporizer 500 is typically cold so that there is no preexisting warm fuel vapor in the volume 504. During this startup time, a heated impact plate 526 is used to vaporize the liquid spray from the injector 502. This follows the techniques described with respect to vaporization chamber 50 (FIG. 2). In one example, the impact plate 526 is a 1/16 inch thick plate with 1/32 inch holes through the thickness of the plate 526, the space 528 below the plate serving as additional vapor storage volume for both running and cold start operation, the holes enabling vapor to pass back and forth through the plate 526. The plate 526 is thermally conductive metal, preferably aluminum. Glow plugs 524A, 524B heat the impact plate 526. The glow plugs 524A, 524B are powered by the electrical system of the engine. In the arrangement shown, the glow plugs 524A, 524B are turned on during the cold startup period and then turned off by a controller (not shown). A thermocouple 530 measures the temperature of the impact plate 526 for thermal control of the system during running conditions. The controller uses feedback from the thermocouple 530 to control the glow plugs 524A, 524B to maintain a specific temperature in the volume 504. The controller may use proportional, derivative, and integral linear control rules to maintain the temperature in the volume 504. As previously stated, in some examples, the controller maintains the temperature in the volume 504 at the vaporization temperature.

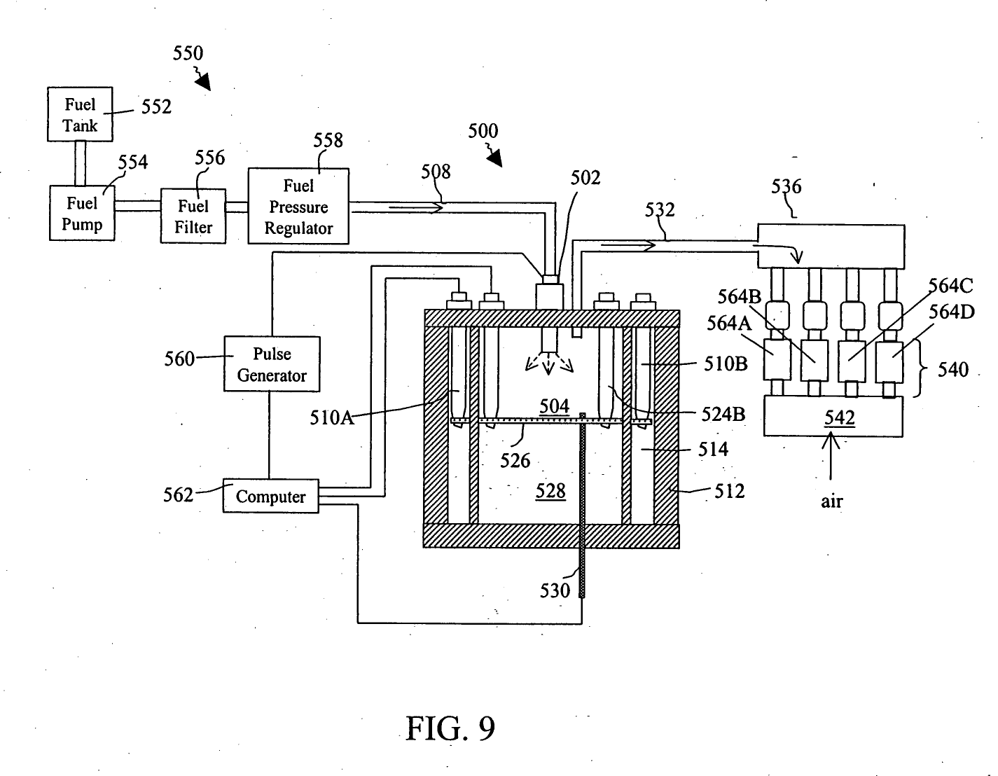

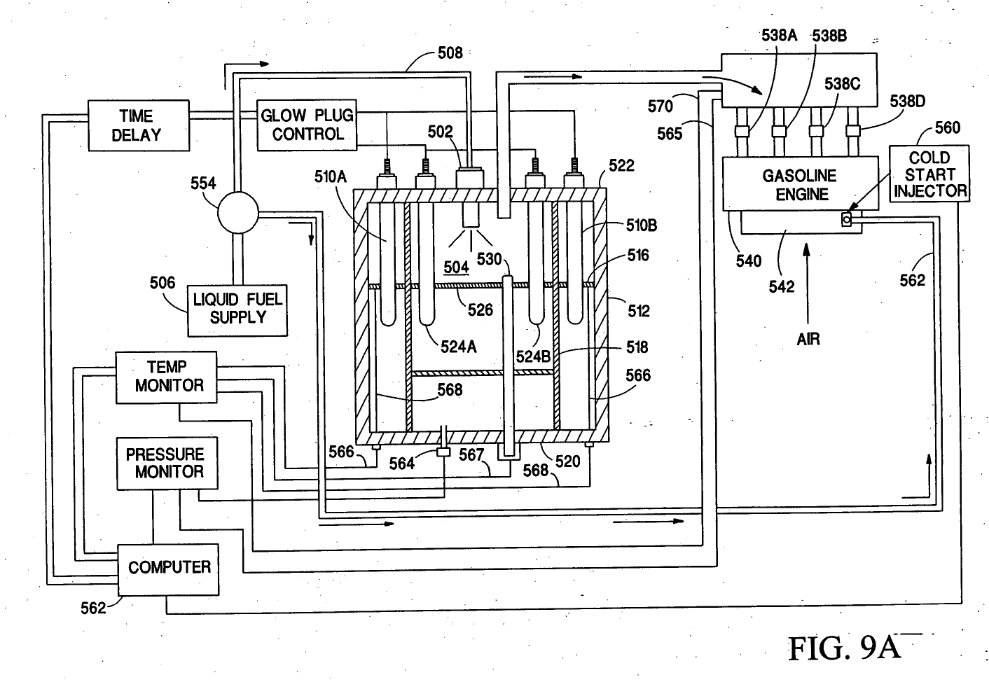

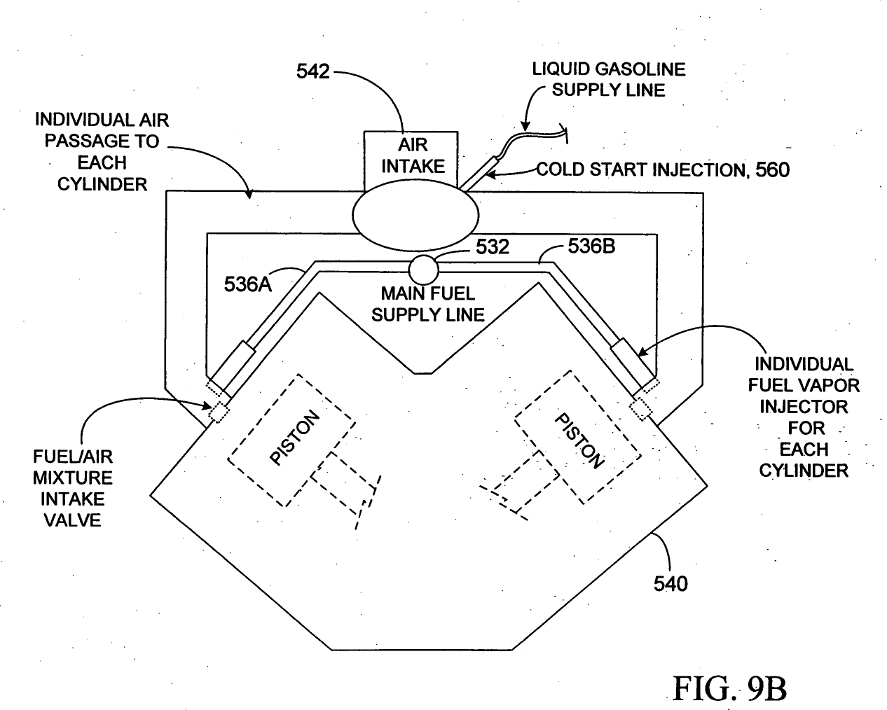

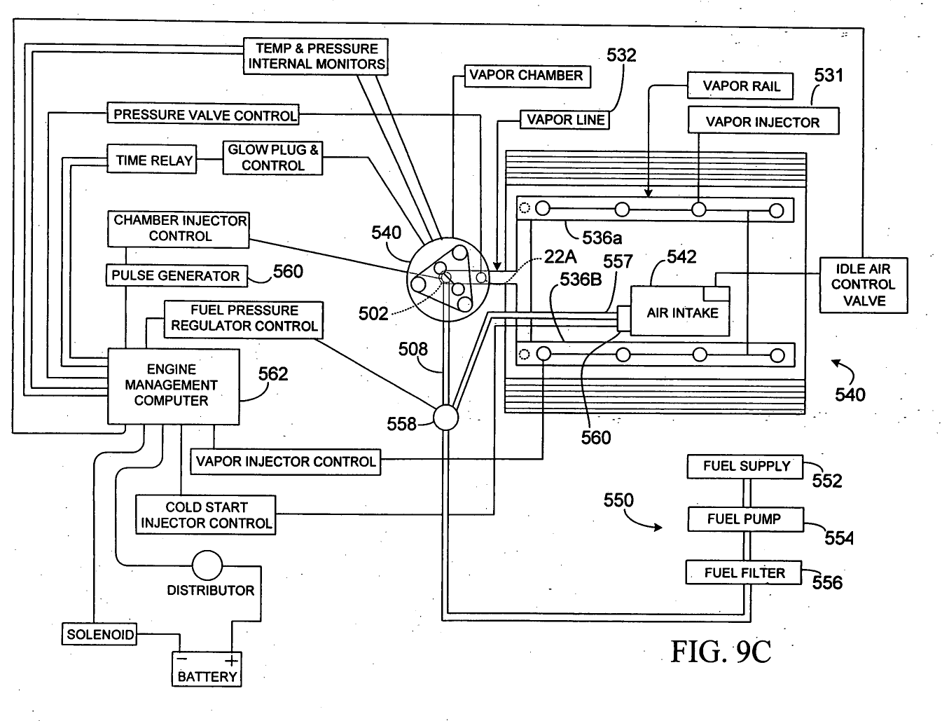

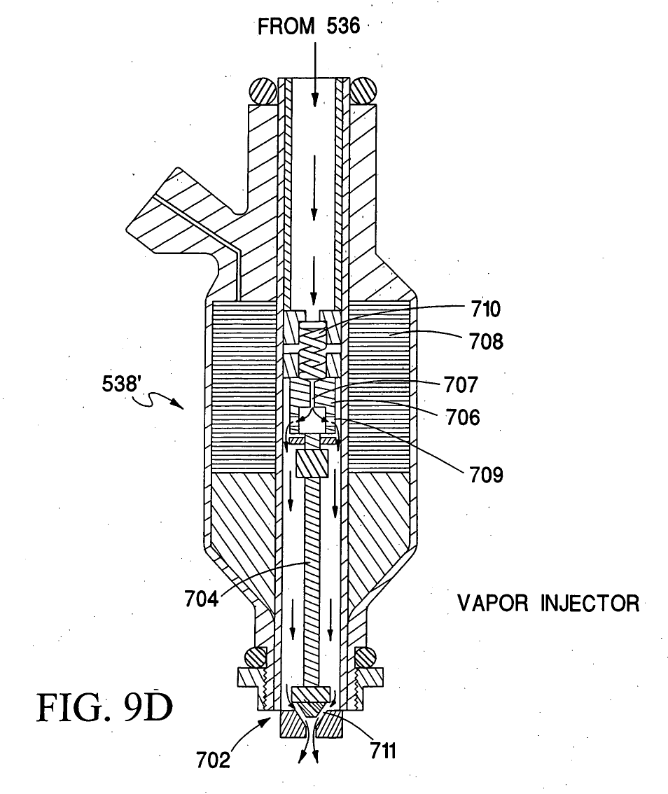

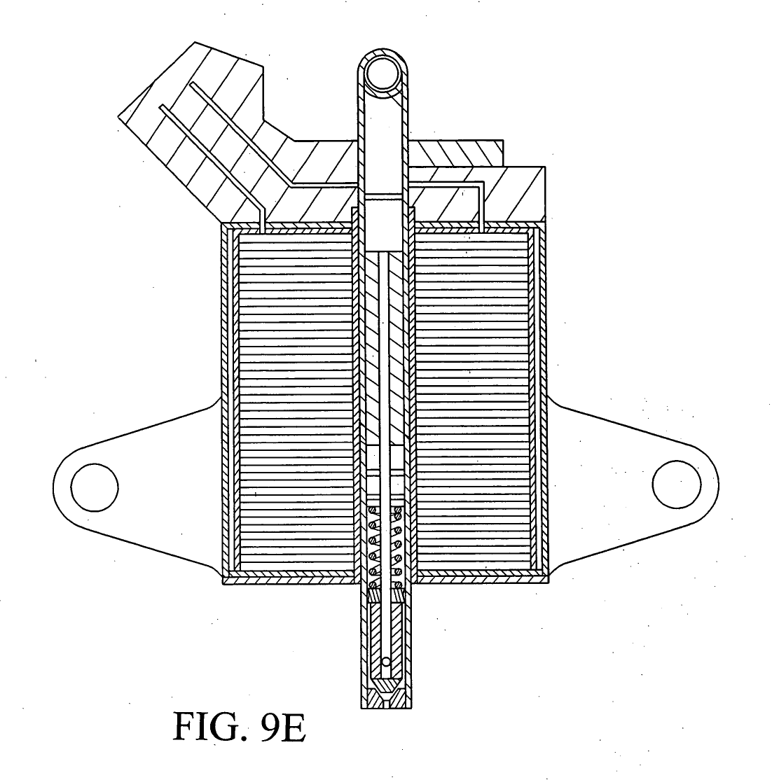

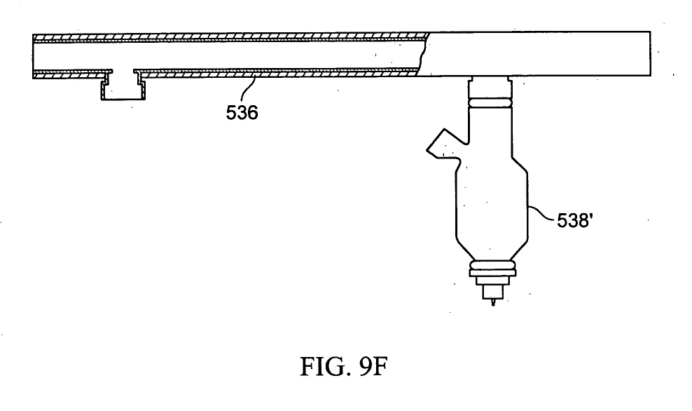

As vapor is generated in the vaporizing volume 504, the vapor fills the channel 532 and vapor manifold 536. It may pass through a flow restrictor not shown such as restrictor 160 of FIG. 3. Vapor injection valves 538A, 538B, 538C, and 538D, under computer control, time the injection of vapor fuel for respective cylinders (not shown) of the engine 540 through respective 1/16 inch holes. The engine 540 also receives air from air manifold 542. The fuel vapor injection may occur directly into the cylinders through vapor injection valves as suggested in FIG. 9, or in respective air paths immediately preceding air intake valves of the respective cylinders.

Referring to FIG. 8A, a vaporizer 544 is similar to the vaporizer 500 except that it has heat-conductive features as described above with respect to FIG. 6. The glow plugs 510A, 510B are press fit in the cylindrical wall 512 and the heat from the glow plugs 510A, 510B is transferred via a thermally conductive metal 546 to the volume 504. The volume 514 contains an amount of the thermally conductive metal 546 that may be liquid under operating conditions. In some examples, the metal 546 can be heated to about 300° F. In some of these examples, the thermally conductive metal 546 is sodium. Heat is transferred from the glow plugs 510A, 5101B to the thermally conductive metal wall 518, thence to the thermally conductive metal 546 and thence to the thermally conductive wall 518.

Referring to FIG. 8B, the vaporizer is similar to that of FIG. 8, with further features. Two spaced apart transverse plates are provided in the pressure volume. Impact plate 526A, see FIG. 8C, is disposed to directly encounter downwardly projected liquid spray from the injector system. It is imperforate in its center region for maximizing the area for interception and heating of liquid particles of the spray. There is a peripheral array of passages 527A through the thickness of the plate, through which vapor may move downwardly to vapor storage in the region below, and upwardly from storage for passage to the engine. Spaced part way below plate 526A is secondary plate 526B. It is more highly perforate. Since it faces heated plate 526A and the ends of the glow plugs 524A′ and 524B′, it is heated by radiation as well as by convection. It serves to keep hot the vapor in the storage volume below plate 526A. When the vaporizer is oriented vertically as shown, any excess liquid that reaches the outside region of plate 526A, can progress through passages 527A by gravity down to plate 526B where it may be vaporized. If any liquid passes through plate 526B to the bottom of the vaporizer, it may be removed by a pressure-preserving drain provision not shown. In one example, plate 526A has two diametrically opposite holes e.g. of 0.235 inch diameter to receive the glow plugs, while the peripheral holes 527A may be of 0.076 inch diameter. Holes in the bottom plate 526B may have a diameter of 0.085 inch.

Also shown in FIG. 8B is a control system by which the temperature of plate 526A, the pressure of the pressure chamber 540A, and temperature at selected points on the annular heat-conductive ring 516 are monitored. Additional thermocouples not shown such as thermocouples 158 and 530 may be employed. Based upon the monitored values a computer 562 controls energization of the two sets of glow plugs 510 and 524 by the battery of the engine system. The computer may be a computer dedicated to the vaporization-based fuel system, or the general engine management computer.

Referring to FIG. 9, a vaporizing system 550 includes the vaporizer 500 of FIG. 8 and additional components. The liquid fuel supply 506 includes fuel tank 552, electric fuel pump 554, fuel filter 556, and fuel pressure regulator 558. Liquid fuel from the fuel tank 552 is pumped by the fuel pump 554 through the fuel filter 556, and through pressure regulator 558 to arrive at the liquid spray injector 502 under pressure. The vaporization system 550 also includes a pulse generator 560 capable of generating pulses to turn the liquid injector 502 off and on. A computer 562 controls the frequency and width of pulses generated by the pulse generator 560. The frequency and width of the pulses relate to the desired power demands on the engine 540. The computer 562 also receives feedback from the thermocouple 530 to control activation of glow plugs 510A, 51OB according to appropriately established control rules to maintain a desired temperature in the volume 504. The engine 540 includes air intake manifold 542 that supplies air to cylinders 564A, 564B, 564C, 564D, and an appropriate injection system for the fuel vapor for the respective cylinders as described with respect to FIG. 8. In other examples, the engine 540 of course may have a different number of cylinders, and other configurations.

Referring to FIG. 9A, an engine system has the features of FIG. 9, combined with further features. A cold start liquid fuel injector system is associated with the air intake and manifold system 542 of the engine, fed by fuel line 562 from fuel pump 554. The cold start injector is constructed and arranged to inject a spray of liquid fuel into the combustion air to facilitate start-up and running in cold conditions. It may be implemented to function only while the vapor-producing system comes up to pressure, or it may be implemented to also assist the fuel vapor system under specified power demand situations. In the system illustrated, cold start liquid fuel injector 560 is arranged to inject atomized liquid fuel spray into the central airflow, the resulting air-fuel mixture to be divided by the air manifold to serve all cylinders. In other embodiments separate liquid fuel injectors may be employed for subsets of cylinders or for respective individual cylinders.

The engine management computer has inputs from critical monitoring locations to provide data from which it can select optimum operating conditions from moment to moment for the combined system of the fuel vaporizer and the cold start liquid fuel injector. Besides inputs that are typical of available computer controlled engines, the inputs include temperature and pressure of the vaporization chamber 504, of the main vapor supply line and of the vapor distribution rail, and temperature of the impact plate 526 and the heat distribution system in the outer heating chamber of the vaporizer. For instance, pressure inputs are conveyed from monitors 564 and 565 at, respectively, the vaporizer and the fuel vapor rail, and temperature inputs are applied from temperature data line 567 monitoring temperature of impact plate 526, data lines 566 and 568 monitoring temperature of the heat distribution ring 516 of the vaporizer and from temperature monitor 570 at the fuel vapor rail.

In FIGS. 9B and C, a system similar to that just described is diagrammatically illustrated with respect to a V-8 engine. Two fuel rails 536A and 536B supply respective sets of four fuel spray vapor injectors, while the cold start injector 560 is centrally arranged to inject liquid fuel spray into air following the air intake 542. Also illustrated in this figure is pressure control valve 22A, for controlling the pressure in the vapor supply line, and idle air control valve which is controlled by the engine management computer.

The function of a fuel vapor injector 531 is to accurately meter fuel vapor to its respective cylinder on command by an electronic signal pulse controlled by the computer. The pulse is timed with respect to the power stroke of the engine, and is of duration suitable to pass the desired volume of vapor. When de-energized, the valve is closed, preventing unwanted flow of vapor or backflow. Presently it is preferred to employ a pintle valve for this purpose. As is known, a pintle is a finely machined tapered part, typically of stainless steel, that normally sits upon a matching tapered valve seat, the pintle passing fluid only when lifted from its seat. The size of the seat and pintle, as well as the downstream nozzle or outlet, determine the size and pattern of the injected flow.

FIG. 9D diagrammatically illustrates a solenoid-operated, pintle-based fuel vapor injector, 538′. Pintle valve assembly 702 is constructed, on each actuation, to pass a fuel vapor charge for a power stroke of the cylinder with which it is associated. Its basic construction is similar to that of a liquid fuel injector, except that its passages are characteristically substantially larger to enable the larger volumetric flow required for a vapor charge of the same weight. An operating rod 704 extends from the pintle member to a translatable armature 706 of material selected to magnetically interact with solenoid coil 708. When the coil is energized under computer control, the armature is raised by magnetic force to the position shown, overcoming the resistance of return spring 710. When solenoid coil 708 is de-energized, its magnetic field collapses, and the spring returns the pintle member to its firmly closed position against its seat. A vapor passage extends along the entire length of the moving structure, to enable fuel vapor to move freely from vapor fuel rail 536 through the injector assembly to the pintle-valved port at the bottom of the vapor injector. In the particular arrangement of this figure, the flow passage is through the hollow center of return coil spring 710, into a central passage 706 of the armature, thence out side outlets 709 of the armature, to flow along the outside of operating rod, then outside past a guide to the open central valve passage 711. In one example the outlet passage of the vapor injector pintle valve is 0.032 inch (in comparison to 0.004 to 0.008 inch for a liquid injector, for instance). In some instances, multiple vapor outlet orifices are provided at the discharge side of the pintle member of the vapor injector to disperse the vapor flow. The materials and design of the vapor fuel injectors are selected to withstand the vapor temperature of the hot vapor and provide long life.

In FIG. 9E, a cold start liquid spray injector is diagrammatically illustrated. It has a solenoid and pintle valve arrangement similar to that of the vapor injector, however its liquid outlet passage is of 0.004 inch diameter, and the other passages through the device are correspondingly small.

In FIG. 9F fuel rail 536 is shown, sized to provide fuel vapor to a set of fuel vapor injectors, 538′.

FIGS. 9G-1 through 9G-4 diagrammatically illustrate an engine cylinder of a fuel vapor injector-fed, four stroke gasoline engine. At the critical admission stroke, fuel vapor is injected to the discrete air inlet port for that cylinder, timed with the opening of the air inlet valve. Following that stroke, in which the fuel and combustion air enter the cylinder, conventional compression, power and exhaust strokes occur. There are significant differences in performance over a conventional engine. At the end of the compression stroke, virtually all of the fuel is in vapor form, in contrast to the significant quantity of liquid droplets that still exist at this stage in a conventional gasoline engine. In the power stroke, the spark is timed to optimize the crank angle for the more immediate and thorough combustion that can take place, thus enabling more useful power to be derived from a given weight of fuel than is obtained in conventional gasoline engines. Furthermore, retention of liquid fuel in crevices of the engine during the power stroke is avoided. At the exhaust stroke, the emissions are substantially free of unburned hydrocarbons and particulates while other emissions can be at acceptable or improved levels.

The principles described are useful with various internal combustion engine designs. A further example is that of a two stroke gasoline engine. While two stroke engines are advantageous in providing more power per engine weight that four stroke engines, they suffer from worse combustion properties. It is realized that principles of the invention can be employed to improve combustion in two stroke gasoline engines. Fuel vapor may be introduced to a two stroke engine centrally to combustion air, or by vapor injection at the air inlet port of each individual cylinder generally in the manner described above. In other cases, direct gasoline vapor injection into each cylinder may be employed, for instance after the exhaust port of a cylinder of a two stroke engine has been closed but before the compression stroke is completed. Another category of engines with which the fuel vaporizing principles are useful is the rotary engine (such as a Wankel engine) in which the moving part of the combustion region is rotary rather than reciprocating.

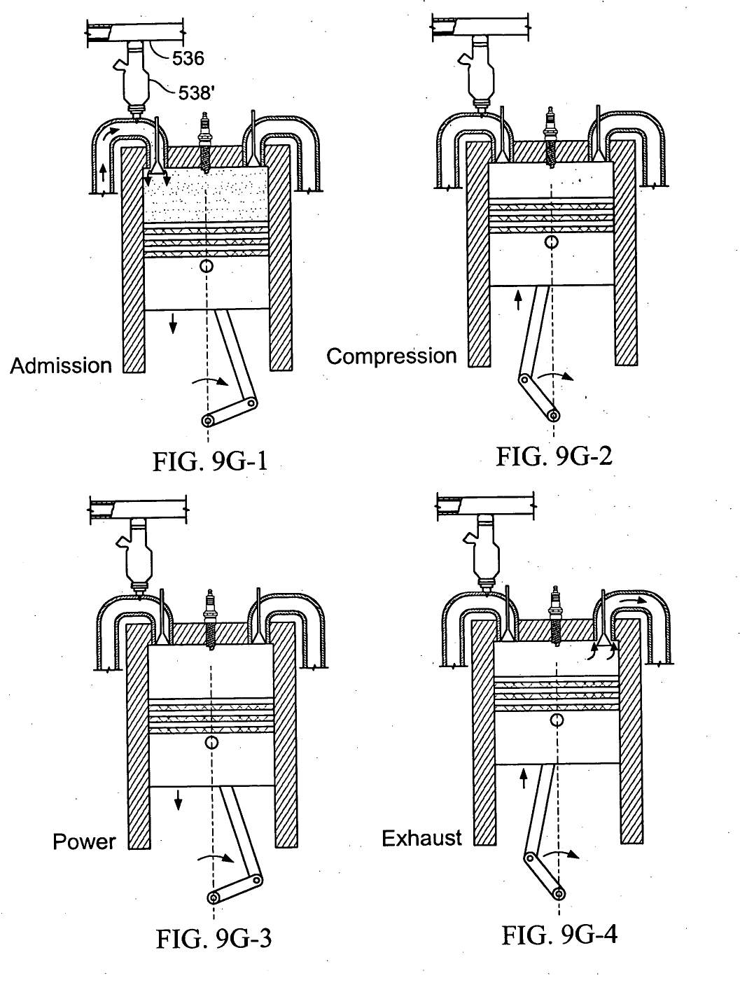

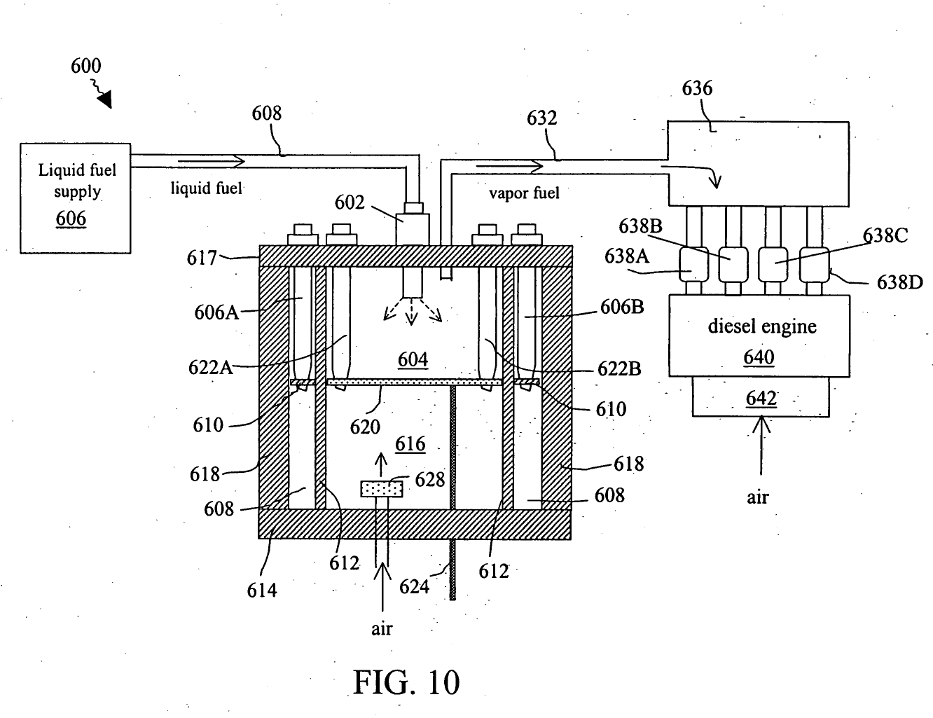

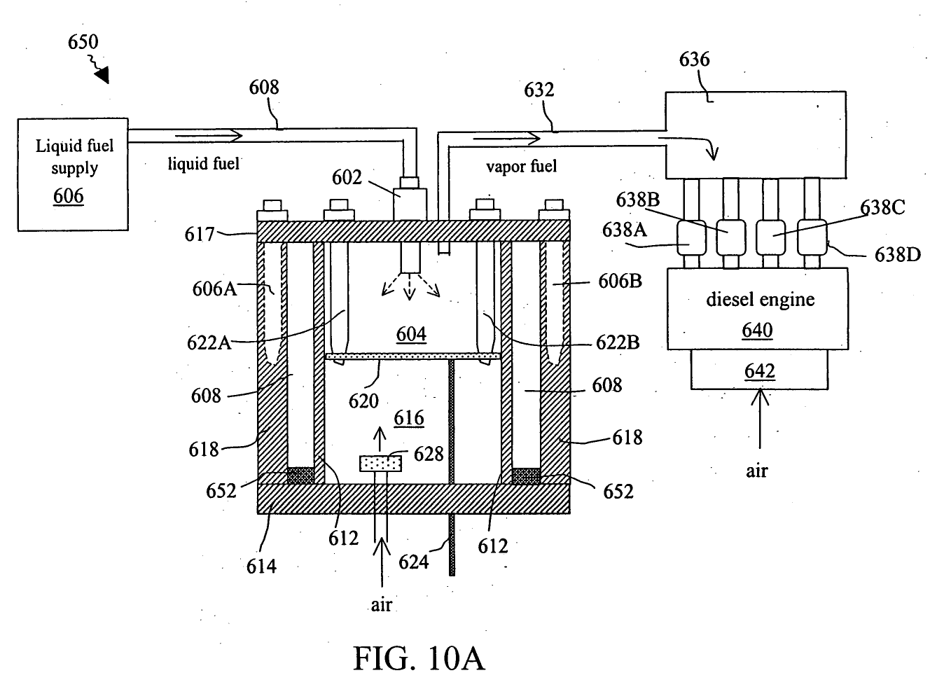

Principles described are also useful with diesel engines. Referring to FIG. 10, a vaporizer 600 delivers diesel fuel vapor to a diesel engine 640. The diesel engine 640 is associated with an electrical system capable of supplying electrical power. The vaporizer 600 includes an injector 602 that sprays liquid diesel fuel into the volume 604 at a pressure through one or a set of small holes. In one example, the liquid fuel injector 602 has a single hole orifice of about 0.001 inch in diameter. The injector 602 is electronically controllable such that an electrical “ON” signal opens the injector while an electrical “OFF” signal shuts the injector. The spray from the injector 602 forms a cone of spray about an axis. The vaporization volume 604, during warm running conditions, contains recirculating fuel vapor that is heated by heat from surrounding cylindrical wall 618. Similar to the process illustrated in FIG. 1, the vaporizer 600 vaporizes the spray of liquid diesel fuel from the injector 602 by vigorous mixing of the spray with recirculated, heated fuel vapor that previously has moved over and received added heat from the wall 618. During warm running conditions, the temperature in the volume 604 is maintained at the vaporization temperature.

A limited amount of pressurized air is introduced into the volume 616, and thus into volume 604, via a pressure valve 628, from an air pump, which may for instance be a small positive displacement air pump. This air disseminates and adds to the circulation and mixing action upon the diesel spray in volume 604, and may also serve a carrier gas function in transfer of pressurized flow to the engine.

As with previously described examples, the cylindrical wall 618 is heated, through heat-transfer, by glow plugs 606A and 606B. The glow plugs 606A, 606B are powered by the electrical system of the diesel engine. Operable glow plugs for this application, by Bosch, are available from Mercedes-Benz USA, LLC of Montvale, N.J. as part number 001.159.2101, and see FIGS. 20-22 below. In other examples (not shown), additional glow plugs may be used to heat the cylindrical wall 612. The glow plugs 606A, 606B are located in an annular space 608 that extends around the volume 604. Glow plugs 606A, 606B transfer thermal energy to the wall 618 via an annular, thermally conductive metal ring 610 that is press-fit about the cylindrical member 612. A cylindrical wall 618 surrounds the annular space 608. The cylindrical walls 612, 618 rest on a bottom plate 614 and a top plate 617 encloses the structure. Sealing rings between the plates 614, 617 and the cylindrical walls 612, 618 enable the pressure in the volume 604 to be maintained. The parts 612, 614, 617, and 618 are made of thermally conductive metal, e.g. aluminum or a suitable high temperature alloy. In one example, the cylindrical wall 612 is ⅛ inch thick while the volume 604 is 2¼ inch in diameter.

A liquid diesel fuel supply 606 provides liquid fuel under pressure via fuel line 608 to the injector 602. The pressure of the liquid diesel fuel in the fuel line 608 is higher than atmospheric pressure while the pressure in the volume 604 is also higher than atmospheric pressure during warm running conditions but lower than the pressure in the fuel line 608. In some examples, the diesel liquid in the fuel line 608 is at a pressure between about 60 to 100 pounds per square inch above atmospheric (psig) while pressure of the diesel vapor in the volume 604 is between about 40 to 50 psig, with a differential between the two pressures as previously described.

During startup of the engine 640, the vaporizer 600 is typically cold so that there is no preexisting warm diesel fuel vapor in the volume 604. During this startup time, a heated impact plate 620 is used to vaporize the diesel liquid spray from the injector 602. This follows the techniques described with respect to vaporization chamber 50 (FIG. 2). In one example, the impact plate 620 is a 1/16 inch thick plate with 1/32 inch holes through the thickness of the plate 620 with a storage volume 616 below the impact plate 620. The holes enable diesel vapor and the air to pass back and forth through the plate 620. The plate 620 is thermally conductive metal, e.g. aluminum or a suitable high temperature alloy. Glow plugs 622A, 622B heat the impact plate 620. The glow plugs 622A, 622B are powered by the electrical system of the diesel engine. The glow plugs 622A, 622B are turned on during the cold startup period and then turned off. A thermocouple 624 measures the temperature of the impact plate 620. A controller (not shown) uses feedback from the thermocouple 621 to control the glow plugs 606A, 606B to maintain a specific temperature in the volume 604. The controller may use proportional, derivative, and integral linear control rules to maintain the temperature in the volume 604.

As diesel vapor is generated in the vaporizing volume 604, the diesel vapor fuel fills and moves through the vapor channel 632 into vapor manifold 636. Vapor fuel valves 638A, 638B, 638C, and 638D regulate the flow of diesel vapor fuel into cylinders (not shown) of the engine 640. The engine 640 also receives air from air manifold 642. Such a system may be used for only a partial fuel charge for a cylinder, relying upon other techniques to complete the charge. Such techniques are described below.

Referring to FIG. 10A, a vaporizer 650 is similar to the vaporizer 600 except that it has heat-conductive features as described above with respect to FIG. 6. The glow plugs 606A, 606B are press fit in the cylindrical wall 618 and the heat from the glow plugs 606A, 606B is transferred via a thermally conductive metal 652 to the volume 604. The volume 608 contains an amount of the thermally conductive metal 652 that may be liquid under operating conditions. In some examples, the metal 652 can be heated to about 300° F. In some of these examples, the thermally conductive metal 652 is sodium. Heat is transferred from the glow plugs 606A, 606B to the thermally conductive metal wall 618, thence to the thermally conductive metal 652 and to the thermally conductive wall 612.

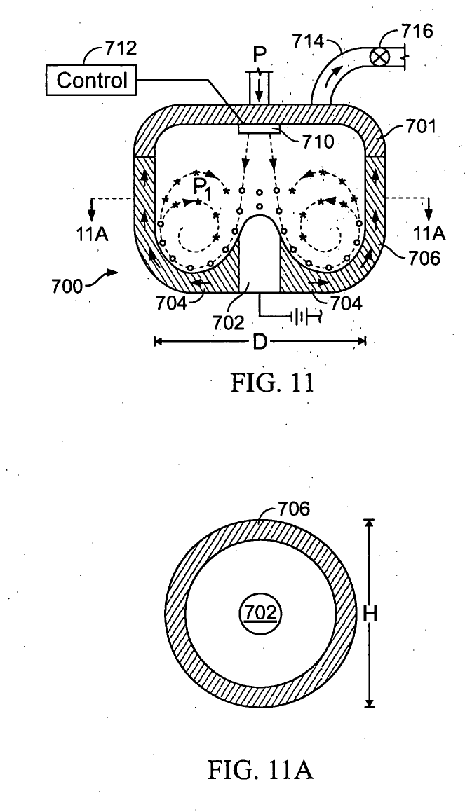

Principles described are also applicable to decentralized vaporization of fuel for an engine. An important case is a vaporizer dedicated to a single cylinder of a piston engine. A vapor injector may be associated directly with such a vaporizer. In the embodiment of FIGS. 11 and 11A, vaporization is produced by combined impingement-contact heating and free-space mixing based on heat produced by a central heater. In the example of these figures, glow plug 702 is located centrally in the bottom of a cup-shaped thermally conductive member 700. As shown, the glow plug has its upwardly-directed hot end exposed for contact by liquid spray. Cup member 700 is comprised of a transversely extending heat-conductive bottom wall 704, which is in heat-receiving relationship with the central glow plug, and upstanding outer heat-conductive sidewall 706, which is in thermal continuity with the bottom wall to also receive heat from glow plug 702. The top of the cup is closed by top member 701 to complete a pressure chamber that is constructed to operate at substantial super-atmospheric pressure P₁. The inner surfaces of the cup define a heat-transfer surface for fluids. Located in the top member is a liquid spray injector 710. It is directed downwardly, toward the glow plug, and is constructed and arranged so that a significant portion of its spray contacts the glow plug and regions of the heat-transfer surface close to it. As in the previous embodiments there is a vapor exit channel 714. It, and an associated outlet control system 716, are denoted diagrammatically. These are effective to maintain super-atmospheric pressure in the vaporization chamber. As illustrated, the exposed surface of bottom wall member 704 is shaped as a section of a torroid, to guide the entering flow into a torroidal mixing motion. In radial cross-section, the bottom surface of the cup progresses from the exposed surface of the cylindrical glow plug in a curved manner, outwardly, downwardly, curving through horizontal, then outwardly, upwardly to blend into outer wall 706 of the cup. This surface cooperates with the downward, axi-symmetric spray to guide the liquid spray, as it heats, and vapor, as it is produced, into a circulating flow useful to provide heat exchange by mixing. At the top of its circulation, the flow turns inwardly to encounter and mix with the atomized particles of freshly arriving liquid spray. This aids in vaporization of the sprayed liquid particles. The higher the pressure within the chamber, the greater is the density of produced vapor, the greater is the heat-transfer by mixing, and hence the smaller may be the dimensions of the vaporizer. It is realized that this arrangement can be sufficiently compact to be practical at an individual engine cylinder or adjacent a small number of cylinders. In production versions, the glow plug and the bottom of the cup-shaped chamber, or indeed the whole chamber, can be manufactured as a unit, without joints in the internal surface. For instance a casting of heat-conductive, heat resistant metal may have a continuous bottom surface and a central depression in its underside into which a resistive heater element, such as that used in glow plug, is sealed, the central part of the cup member effectively becoming a glow plug. In certain embodiments, the unit may be constructed as a high pressure vessel, to enable elevation of the pressure of operation to pressure in the hundreds of psi, or higher, with care being taken to select materials for the walls of the chamber that can withstand the corresponding high temperature of vaporization. In some cases the material of at least a part of the chamber may be a ceramic. A portion of a ceramic member, itself, can form an electrically resistive heating element of the vaporizer, generally in the manner presently used in some makes of glow plugs.

Dedicated vaporizer designs can be combined with pintle valves for both admitting liquid spray for vaporization and for controlling flow of the produced, pressurized fuel vapor.

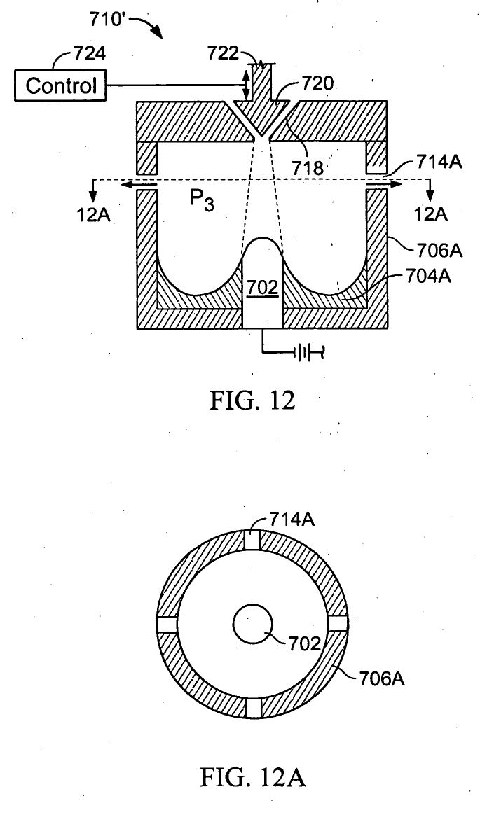

In the embodiment of FIGS. 12 and 12A, a liquid supply pintle valve 720 operated by a suitable control 724, and seated on a valve seat in a wall of the chamber, moves in translating motion to alternately open the passage to admit liquid spray to the chamber and to seal the chamber. A set of side vapor outlets 714A are provided in the wall 706A of the chamber for directing fuel vapor to one or more cylinders of an engine.

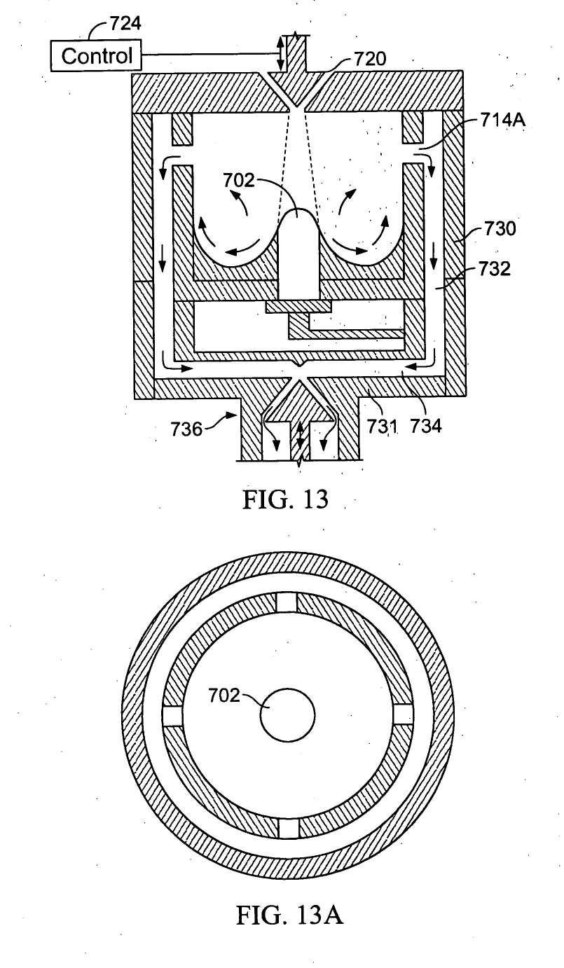

In the embodiment of FIGS. 13 and 13A, a surrounding cylindrical wall 730 and bottom wall 731, guide flow through from the outlets 714A downwardly and then radially inwardly to merge into a single flow that is controlled by a vapor flow control valve, here shown as vapor pintle valve 736.

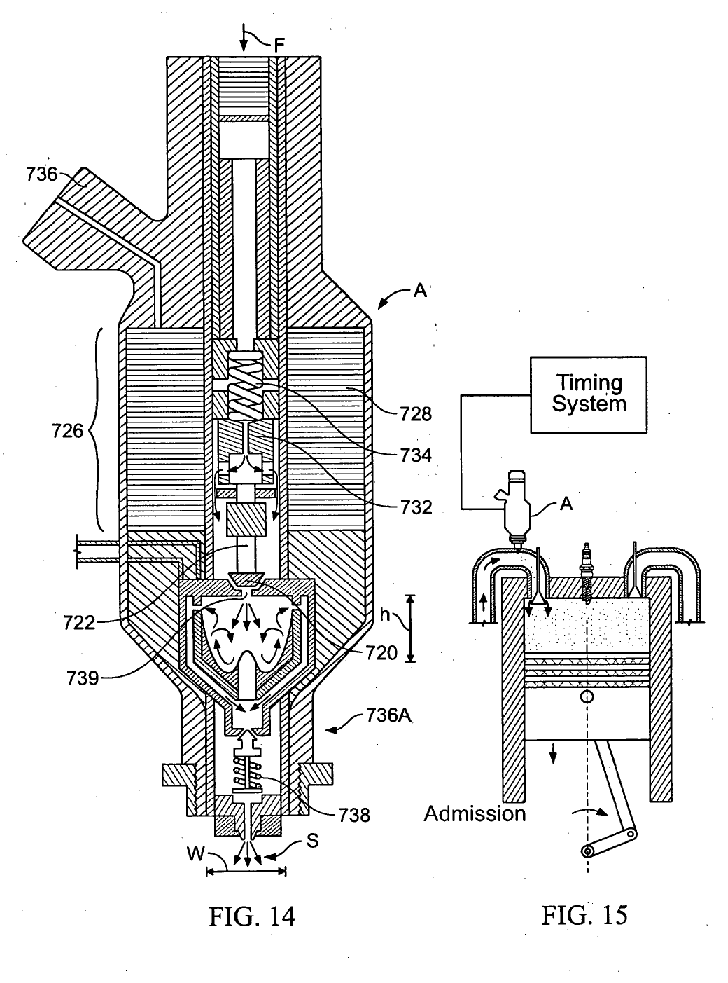

In the vaporizer A of FIG. 14 a solenoid assembly 726 is provided to activate pintle valve 720 to produce a liquid spray from the valve outlet nozzle. An iron armature 732 is arranged in driving relationship with the pintle member. The parts of this solenoid assembly are constructed to provide a continuous liquid flow path from the pressurized liquid fuel line to the pintle valve 720 and spray nozzle 739, following principles previously described.

When activated by electric current flowing in surrounding solenoid coil 728, the magnetic field produced by the coil overcomes the resistance of return spring 734, pulling the pintle member upwardly from its valve seat. This produces fuel flow from the pressurized liquid supply line through the pintle valve and injection of liquid spray into the vaporization chamber through nozzle 739. Upon deactivation of the coil, the return spring 734 returns the pintle member to closed position on its valve seat.

Also, at the vapor outlet, the vaporizer of FIG. 14 includes a spring-loaded vapor control pintle valve 736A, which includes return spring 738. It enables vapor flow when the pressure of fuel vapor in the chamber exceeds the resistance of the spring, and closes the valve when the pressure of the vapor drops below that level.

In the embodiment of FIG. 15, the vaporizer is sized and arranged to supply fuel to a single cylinder of an engine. In the case shown, the timing system of the engine activates the solenoid coil 728 in advance of each power stroke of the cylinder, to provide a fuel vapor charge. The timing, flow rate and duration of the liquid spray pulse, and the degree of heating are selected and managed under computer control in accordance with the type and demand of the engine. The attained pressure of heated vapor in the vapor chamber may be employed to provide the motive force for the vapor to flow to the point of fuel injection.

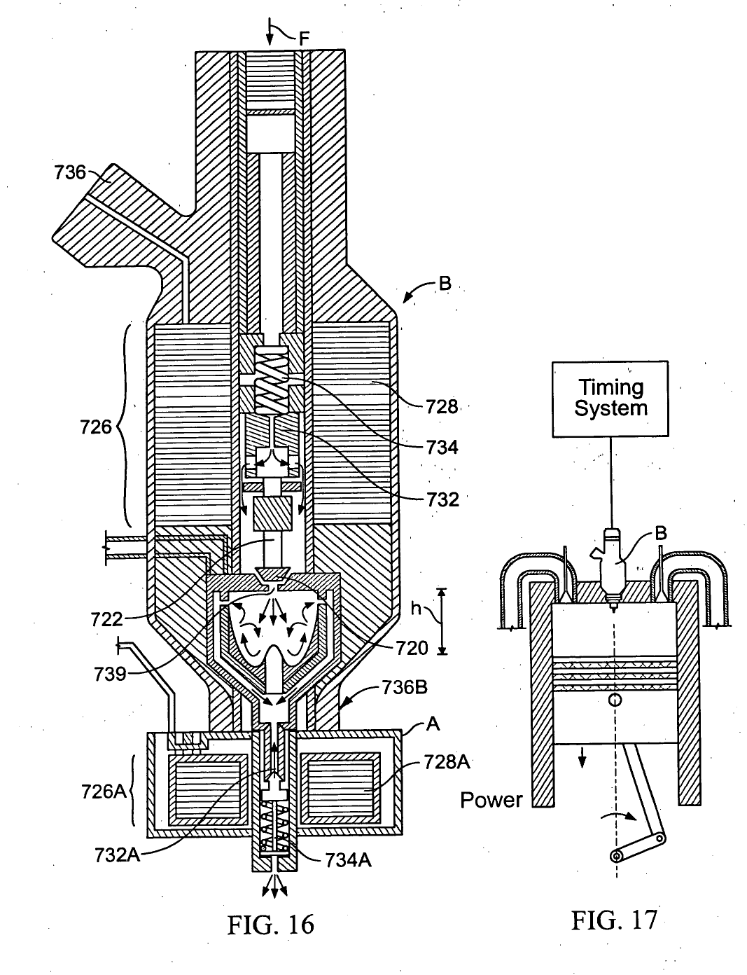

The vaporizer B of FIG. 16 is constructed to itself also serve as a computer controlled vapor injector. In vaporizer B, as was the case with vaporizer A, a solenoid assembly 726 is provided to activate the liquid spray pintle valve 720 to enable liquid flow and production of liquid spray into a vaporization chamber. An iron armature 732 is arranged in driving relationship with the pintle member. When activated by current flowing in surrounding solenoid coil 728, the magnetic force of the coil upon the armature overcomes the resistance of return spring 734, pulling the pintle member 720 upwardly from its valve seat. This produces liquid fuel flow F from the pressurized supply line through the liquid spray injector, to produce a spray of atomized liquid particles. Upon deactivation of the coil, return spring 734 returns the pintle member to closed position on the valve seat. Further, in the vaporizer B of FIG. 16, the outlet pintle valve 736B is also provided with a solenoid assembly 726A to activate the vapor release pintle valve to enable vapor flow to the engine. In this case return spring 734A is sized to provide a closing force exceeding the force of the contained pressurized vapor. An iron armature 732A is arranged in driving relationship with the pintle member. When activated by current flowing in surrounding solenoid coil 728A, it overcomes the resistance of return spring 734A, pulling the pintle member downwardly from its valve seat. This produces fuel vapor flow from the pressurized vaporization chamber. Upon deactivation of coil 728A, the pintle member is returned to closed position on the valve seat by the spring 734A. The parts of this injector assembly are constructed to provide a continuous vapor flow path from the pintle valve to the vapor delivery point of the unit by suitable passages past or through the operative members of the pintle actuation assembly, according to principles described earlier.

Vaporizer B of FIG. 16 is sized and arranged to supply fuel to a single cylinder of an engine. When used in the general arrangement shown in FIG. 15, the timing system of the engine activates both solenoid coils in synchronization with the engine. The liquid solenoid is activated to provide a liquid fuel spray charge to the cylinder. The timing, flow rate and duration of the liquid spray pulse and the heating interval between liquid fuel injection and activation of the vapor solenoid to discharge vapor to the engine are selected and managed under computer control in accordance with the type and demand of the engine. The attained pressure of heated vapor in the vapor chamber may be employed to provide the motive force for the vapor to flow to the point of fuel injection. The chamber may be constructed for high temperature operation. In one case it is formed of Inconel 617 or other high temperature stainless steel.

The embodiment of FIG. 17 differs from that of FIG. 15 in that the fuel vapor injector B is constructed and arranged to discharge directly into the combustion region of an engine cylinder at the appropriate time. For instance, it may discharge into the cylinder of the specialized two stroke gasoline engine mentioned above. If designed for suitable high pressure, it may inject diesel vapor directly into the combustion space of a diesel engine, i.e. into the diesel cylinder or into a combustion pre-chamber of the cylinder, depending upon the design of the diesel engine. The heating interval between completion of injection of liquid fuel spray into the vaporization chamber and discharge of vapor to the engine can provide important pressure build-up to enable vapor flow. In addition a vapor purging piston timed with the engine, for instance driven by a linear motor, might be arranged to purge the vaporization chamber, to force the vapor through the vapor injection valve, into the compressed air in the combustion region.

In one example, the liquid spray is initiated into the vaporization chamber early during the air-admission stroke of the engine, or even earlier. In a diesel engine, vapor injection would be timed to occur soon after the beginning of the diesel power stroke.

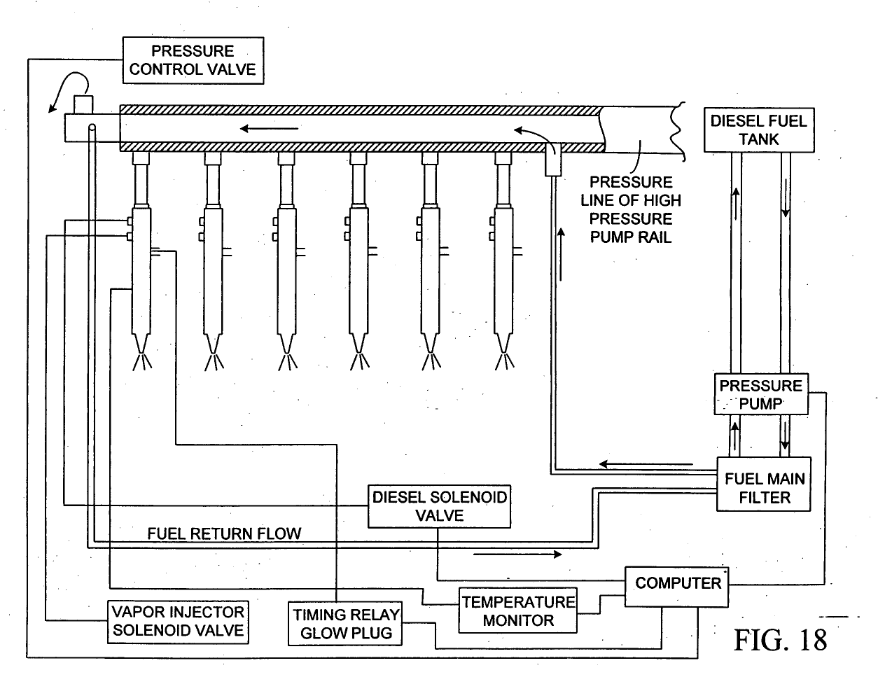

In FIG. 18 a fuel distribution system is diagrammatically illustrated for use with the fuel vapor injectors of the type of FIG. 16. A high pressure liquid diesel fuel rail is supplied by a suitable pump. This rail supplies a set of vaporizer/vapor injectors of the type B of FIG. 16, one for each cylinder. The engine management computer times the actuation of the liquid diesel furnish solenoid valve and subsequently, of the vapor injector solenoid valve, to produce a vapor charge for each power stroke.

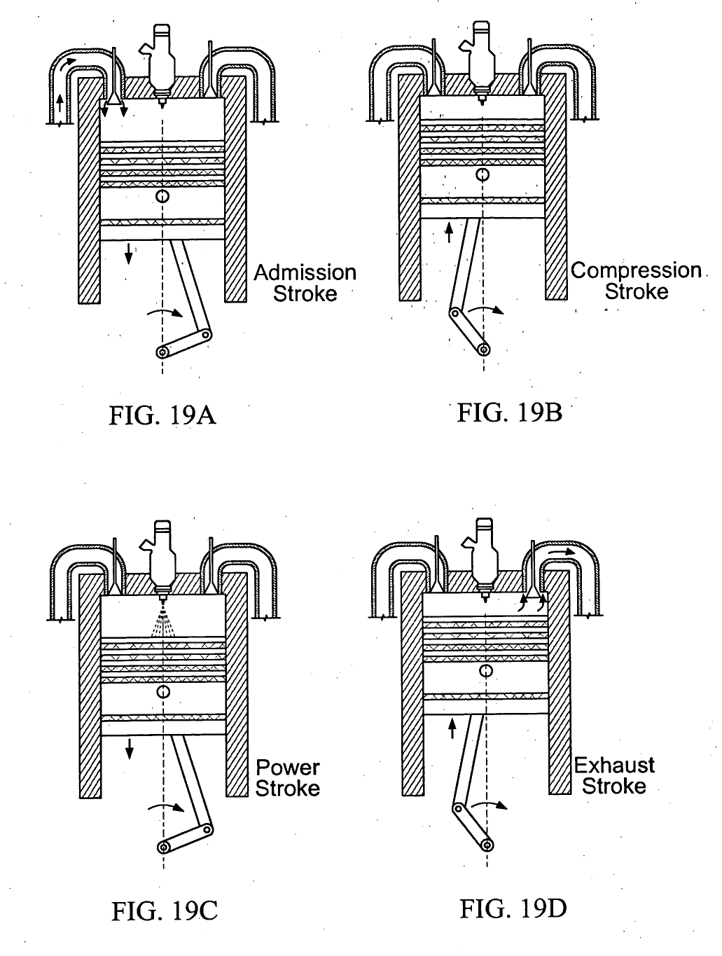

Other arrangements may be made for practical application in a diesel environment, using one or more of the diesel arrangements that have been described. For instance, a diesel vapor injector of the type described may be arranged to inject only a partial fuel charge to the diesel cylinder, with the remaining fuel requirement of each power stroke provided by a liquid diesel fuel injector. In such a case the diesel fuel vapor injection may be timed with the air admission stroke, and may inject directly into the combustion region of the diesel cylinder or into its air inlet port. If done in this manner, it is important that the fuel vapor partial charge be limited in size to not reach the critical value that would create a danger of pre-ignition during the compression stroke. An advantage this system may provide is that of better combustion efficiency as only part of the fuel is supplied by the conventional system that produces particulate emissions and the like. FIG. 19 illustrates the stages of a typical diesel engine.

It is advantageous that the glow plug selected have a long life rating under the conditions of use. Referring to FIGS. 20-22, a long life resistive coil element 802 within a glow plug is advantageously made of platinum alloy wire. The wire may be of 0.012 inch diameter, straight length of 4 inch, wound into a helical coil of length l₁ of about ½ inch. The outer metal tube 812 into which the coil is inserted may be of Inconel 617, of length l₁, of about ½ inch. It may have an inner diameter of about 0.170 inch and wall thickness of 0.035 inch. As shown it has a lower end closed about the lower extension of the coiled wire. This lower end of the wire is welded to the tube. For fast heating of the tube it is advantageous to employ fine glass powder 804 as the predominant electrical insulation between the sides of the coil and tube. Fine, high temperature glass powder is seen to have favorable thermal conductive properties for conducting heat quickly from the coil to the tube, while providing appropriate electrical insulation. The filling may be 100% of the fine glass powder or 90% of the fine glass powder and 10% ceramic powder, for instance. The upper end of the coil is inserted in a receiving aperture and welded to the lower end of central stem 806, which may be of stainless steel. The upper end of the stem 806A serves as an electrical terminal to receive power from the battery. A body 811 e.g. of machined steel is joined to the top of tube 812. A seal member 807 of temperature-resistant fiber extends between stem 806 and the outer body at 810. A long life electrically insulative, pressure seal 808 of high temperature pressure seal glass is formed above member 807, between the electrically conductive connector stem 806 and the outer body. The overall length l₂ of the glow plug unit may be about 4 inch.

A number of systems have been described for illustration. It will be understood that various modifications may be made without departing from the spirit and scope of the inventive contributions. For example, the heat-transfer surfaces may be of other configuration, heating of these surfaces can also be performed by other means of heating, such as other electrical heating techniques, and exterior surfaces of the vaporizer and associated conduits may be provided with thermal insulation and/or auxiliary heating. Accordingly, systems of other designs are within the scope of the following claims.

1. A fuel vaporizer for an internal combustion engine, the fuel vaporizer comprising:
a closed pressure chamber defining a volume,
a heat-transfer surface associated with the volume and arranged to be heated, and
a liquid fuel supply system disposed to emit into the volume, under pressure, an expanding pattern of liquid fuel spray from at least one outlet spaced from the heat-transfer surface,
the chamber and the liquid fuel supply system being constructed and arranged relative to the heat-transfer surface to establish between the at least one outlet and the heat-transfer surface a mixing domain in which the fuel spray, as it progresses through the volume from the outlet, is substantially heated and vaporized by mixing with recirculated, heated fuel vapor that previously has moved over and received added heat from the heat-transfer surface,
the fuel vaporizer being associated with a vapor outflow passage which includes a flow control, the fuel vaporizer constructed and arranged to enable flow of pressurized fuel vapor to the engine while maintaining substantial super-atmospheric pressure within the volume in which vaporization occurs.

2. The fuel vaporizer of claim 1 equipped with an electrical system that comprises a battery and electric source powered by the engine, wherein the heat-transfer surface is heated by electric power from the electrical system.

3. The fuel vaporizer of claim 1 constructed to vaporize liquid fuel in substantial absence of airflow.

4. The fuel vaporizer of claims 1 constructed to vaporize liquid fuel in presence of a limited flow of pressurized air into the pressure chamber.

5. The fuel vaporizer of claim 1, in which the liquid fuel supply system is a liquid fuel injection system constructed to inject controlled pulses of liquid fuel spray into the volume of the vaporizer.

6. The fuel vaporizer of claim 5 constructed to produce pulses of pressurized liquid fuel flow, each pulse of duration of about a second or more.

7. The fuel vaporizer of claim 5 further comprising a controller to produce pulses of pressurized liquid flow of varying duration and/or frequency in response to fuel vapor demand.

8. The fuel vaporizer of claim 5, 6 or 7, in which the liquid fuel injection system comprises:
a signal pulse generator constructed to produce a series of signal pulses according to the fuel requirements of the engine;
a liquid fuel injector;
a liquid fuel line connected to receive pressurized flow from an electric fuel pump and to supply the pressurized fuel to the liquid fuel injector, the liquid fuel injector being constructed and arranged, in response to the signal pulses, to produce through the outlet, pulses of diverging spray of liquid fuel.

9. The fuel vaporizer of claim 5 constructed for use with gasoline engines, in which the liquid fuel injection system comprises an electric fuel pump constructed to provide liquid fuel for injection into the chamber at liquid pressure in the range of about 60 to 100 psig, and the fuel vaporizer is constructed to maintain pressure in the chamber volume in the range of about 30 to 80 psig, with the pressure of the liquid fuel being substantially greater than pressure in the chamber volume.

10. The fuel vaporizer of claim 9 constructed for use in a carburetor type system constructed to provide fuel vapor to a flow of combustion air, the vaporizer constructed to maintain pressure in the chamber between about 65 and 75 psi.

11. The fuel vaporizer of claim 9 constructed for use in a fuel injection system, the vaporizer constructed to maintain pressure in the chamber between about 40 and 50 psi.

12. The fuel vaporizer of claim 9, 10 or 11 constructed to maintain the pressure of liquid for injection at least 5 psi greater than pressure in the chamber volume.

13. The fuel vaporizer of claim 5 constructed for association with a single combustion region of an internal combustion engine.

14. The fuel vaporizer of claim 13 in which the liquid fuel injection system is constructed to inject controlled pulses of liquid fuel spray into the chamber of the vaporizer, each pulse in timed relationship with the engine and in amount suitable for a fuel charge for the combustion region.

15. The fuel vaporizer of claim 13 constructed to provide liquid fuel at pressure above about 100 psig for injection as a spray liquid into the volume of the vaporizer.

16. The fuel vaporizer of claim 15 in which the pressure is above 150 psig.

17. The fuel vaporizer of claim 13 constructed to vaporize diesel fuel and inject diesel vapor for combustion in a diesel cylinder.

18. The fuel vaporizer of claim 1 in which the liquid fuel supply system is constructed to produce a spray having an axis and the heat-transfer surface is a surface of revolution axi-symmetric with the spray.

19. The fuel vaporizer of claim 18 in which the heat-transfer surface surrounds the spray.

20. The fuel vaporizer of claim 19 in which the spray is conical and the heat-transfer surface is substantially cylindrical.

21. The fuel vaporizer of claim 18 in which the heat-transfer surface is defined by thermally conductive metal of thickness between about 1/16 to ⅛ inch.

22. The fuel vaporizer of claim 1 in which the heat-transfer surface includes a transverse surface opposed to the spray.

23. The fuel vaporizer of claim 22 in which the transverse surface is of round form.

24. The fuel vaporizer of claim 22 in which the heat-transfer surface is effectively cup-shaped including a transverse surface opposed to the spray and an outer wall portion surrounding the spray.

25. The fuel vaporizer of claim 22 or 24 in which the transverse surface is associated with at least one electric heater.

26. The fuel vaporizer of claim 25 in which the heater is effectively a glow plug.

27. The fuel vaporizer of claim 24 having, effectively, a single glow plug, the glow plug being centrally disposed with respect to the transverse surface, the glow plug being substantially aligned with the spray.

28. The fuel vaporizer of claim 22 or 27 in which the transverse surface has a shape constructed to receive and deflect the spray in a mixing pattern.

29. The fuel vaporizer of claim 28 in which the transverse surface is a concave torroidal section.

30. The fuel vaporizer of claim 27 constructed to vaporize diesel fuel and inject diesel vapor.

31. The fuel vaporizer of claim 27 constructed to vaporize gasoline and inject gasoline vapor.

32. The fuel vaporizer of claim 1, 22 or 24 in which a heater is associated with the heat-transfer surface and is exposed for direct contact with fuel in the volume.

33. The fuel vaporizer of claim 1, in which a heater is associated with the heat-transfer surface in a manner protecting the heater from contact with fuel in the volume.

34. The fuel vaporizer of claim 1 or 33, in which a conductive substance that can undergo phase change under operating conditions is in contact with a member defining the heat-transfer surface, the substance defining a heat-transfer path between a heater and the heat-transfer surface.

35. The fuel vaporizer of claim 1, in which a heater associated with the heat-transfer surface comprises one or more glow plugs in conductive heat-transfer relationship with the heat-transfer surface.

36. The fuel vaporizer of claim 35, in which a conductive heat-transfer medium extends from at least one glow plug to a member defining the heat-transfer surface.

37. The fuel vaporizer of claim 36 in which the heat-transfer medium is a thermally conductive annular ring member surrounding and in thermal contact with the exterior of a wall which on its interior defines the heat-transfer surface.

38. The fuel vaporizer of claim 35, 36 or 37, in which the electric heater comprises multiple glow plugs spaced apart along a member defining the heat-transfer surface.

39. The fuel vaporizer of claim 1, in which a spray produced by the liquid fuel supply system is directed along an axis, and the fuel vaporizer comprises a transverse member defining the heat-transfer surface, the heat-transfer surface being associated with an electrical heater that is powered by an electrical system of an engine and extending across the axis.

40. The fuel vaporizer of claim 1 in which a heated heat-transfer surface is positioned for impact of liquid fuel spray under cold start conditions to vaporize the liquid, for providing fuel vapor for starting the engine or running the engine cold.

41. The fuel vaporizer of claim 35, in which the heated heat-transfer surface positioned for impact of spray is in a conductive heat-transfer relationship with at least one glow plug for electric heating of the heat-transfer surface.

42. The fuel vaporizer of claim 1 having first and second heat-transfer surfaces, in which first and second heaters are associated respectively with the first and second heat-transfer surfaces.

43. The fuel vaporizer of claim 1, in which both a first and a second heat-transfer surface are associated with a given volume within the chamber, the first heat-transfer surface being associated with a mixing domain and the second heat-transfer surface being disposed for impact by liquid fuel spray at least under cold conditions to vaporize impacting spray.

44. The fuel vaporizer of claim 1, wherein an expanding pattern of liquid fuel spray is distributed about a an axis and in which a first heat-transfer surface is constructed to surround the spray at a distance spaced from the axis and a second heat-transfer surface extends across the axis of the spray.

45. The fuel vaporizer of claim 43 or 44, in which the second heat-transfer surface is defined by a perforated member of thermally conductive material.

46. The fuel vaporizer of claim 43 or 44, in which heating of the second heat-transfer surface is by electric glow plug heating.

47. The fuel vaporizer of claim 1, in which the vapor outflow passage is arranged to discharge into a region of a combustion air conduit associated with an engine, and the flow control is a vapor control valve adapted to be actuated in response to engine power requirements to control flow of vapor into the air conduit.

48. The fuel vaporizer any of claim 47, in which the region of the combustion air conduit is a venturi region.

49. The fuel vaporizer of claim 1, associated with an internal combustion engine having multiple combustion regions, and the vapor outflow passage is arranged to supply a set of fuel vapor injectors each communicating directly or indirectly with a respective combustion region of the engine, the vapor injectors adapted to be actuated in response to power requirements of the engine.

50. The fuel vaporizer of claim 49 in which the fuel vapor injectors are constructed to discharge fuel vapor to the air inlet port regions of respective combustion regions of the engine.

51. The fuel vaporizer of claim 44 in which the fuel vapor injectors are constructed to discharge fuel vapor directly to respective combustion regions of the engine.

52. The fuel vaporizer of claim 1 sized and constructed to provide fuel vapor to a single combustion region of an engine having multiple combustion regions.

53. The fuel vaporizer of claim 52 in which the heat-transfer surface of the vaporizer is effectively cup-shaped including a transverse surface opposed to the spray and an outer wall portion surrounding the spray.

54. The fuel vaporizer of claim 53 in which a glow plug is centrally disposed with respect to the transverse surface, the glow plug having an axis, the axis being substantially aligned with an axis of the spray.

55. The fuel vaporizer of claim 53 or 54 in which the transverse surface is radially curved or sloped, constructed to receive and deflect the spray in a mixing pattern.

56. The fuel vaporizer of claim 55 in which the transverse surface is a concave surface of torroidal section.

57. The fuel vaporizer of claim 52, 53 or 54 in which the flow control is a spring-loaded valve constructed to be opened by pressure in the pressure chamber of the vaporizer.

58. The fuel vaporizer of claim 52, 53 or 54 in which the flow control is constructed to be opened and closed by a timing system of the engine.

59. The fuel vaporizer of claim 52, 53 or 54 in which the liquid fuel injection system is constructed to inject controlled pulses of liquid fuel spray into the volume of the vaporizer, each pulse in a timed relationship with the engine and in amount suitable for a fuel charge for the combustion region.

60. The fuel vaporizer of claim 59 constructed to inject diesel fuel vapor for a combustion region of a diesel engine.

61. The fuel vaporizer of claim 52 in which the liquid fuel injection system is constructed to inject controlled pulses of liquid fuel spray into the volume of the vaporizer, each pulse in a timed relationship with the engine and in amount suitable for a fuel charge for the combustion region, in which the flow control is a vapor injection valve constructed for operation in a timed relationship with the engine and a control system adapted to control the interval between each pulse of liquid spray into the volume and actuation of the vapor valve.

62. The fuel vaporizer of claim 61 adapted for use with a diesel engine the control system constructed to maintain the interval in manner to assure pressure in the vapor chamber sufficient to enable injection of diesel vapor directly into the combustion region at commencement of the power phase of the combustion chamber.

63. A fuel vaporizer for an internal combustion engine having a combustion region, the fuel vaporizer comprising:
a closed pressure chamber defining a volume,
a heat-transfer surface associated with the volume and arranged to be heated, and
a liquid fuel supply system disposed to emit into the volume, under pressure, an expanding pattern of liquid fuel spray from at least one outlet spaced from the heat-transfer surface, the liquid fuel supply system comprising a fuel injection system constructed to inject the spray in controlled pulses, each pulse synchronized with timing of the engine and in amount suitable for a fuel charge for the combustion region of the engine, the heat-transfer surface being effectively cup-shaped including a transverse surface opposed to the spray and an outer wall portion surrounding the spray, the vaporizer having, effectively, a glow plug that is centrally disposed with respect to the transverse surface, the glow plug having an axis, the axis being substantially aligned with the spray, and a vapor flow control comprising a valve constructed to be opened to deliver fuel vapor for the combustion region of the engine.

64. The fuel vaporizer of claim 63 in which the valve through which fuel vapor is delivered is spring-loaded and constructed to be opened by pressure in the pressure chamber.

65. The fuel vaporizer of claim 63 in which the valve through which fuel vapor is delivered is constructed to be opened and closed by a timing system of the engine.

66. The fuel vaporizer of claim 65 associated with a control system adapted to control the interval between each pulse of liquid spray into the volume of the vaporizer and actuation of the valve through which fuel vapor is delivered.

67. The fuel vaporizer of claim 66 constructed to produce diesel fuel vapor and inject the vapor into the combustion region.

68. A fuel vaporizer for an internal combustion engine equipped with an electrical system that comprises a battery and electric source powered by the engine, the fuel vaporizer comprising:
a closed chamber;
first and second heat-transfer surfaces associated with the chamber and arranged to be heated, at least the second heat-transfer surface being heated by electric power from the electrical system; and
a liquid fuel supply system disposed to emit into the chamber, under pressure, at least one expanding pattern of fuel spray of liquid from at least one outlet,
the chamber and the liquid fuel supply system being constructed and arranged relative to the first heat-transfer surface to establish between the at least one outlet and the first heat-transfer surface a vaporizing region in which during running conditions, the fuel spray is substantially heated and vaporized, and
the chamber and the liquid fuel supply system being constructed and arranged relative to the second heat-transfer surface to enable, under cold conditions, impact of liquid spray directly upon the second heat-transfer surface, the second heat-transfer surface being arranged to be heated rapidly and constructed to vaporize impacting spray to provide fuel vapor for the engine under cold conditions.

69. The fuel vaporizer of claim 68 in which the liquid fuel supply system is constructed to produce from the at least one outlet a spray pattern distributed about an axis, the first heat-transfer surface being of the form of a surface of revolution surrounding the spray, and the second heat-transfer surface comprising a surface disposed across the axis in opposition to the general direction of progress of the spray.

70. The fuel vaporizer of claim 68 in which the second heat-transfer surface is heated by at least one glow plug energized by the electrical system.

71. The fuel vaporizer of claim 70 in which the heat-transfer surface is defined by a thermally conductive plate and the glow plug is in thermal contact with the plate.

72. The fuel vaporizer of claim 68 including a control for energizing the glow plug of the second heat-transfer surface only under cold conditions.

73. The fuel vaporizer of claim 68 in which the chamber defines a single volume to which both of the heat-transfer surfaces are exposed for vaporizing action.

74. The fuel vaporizer of claim 68 constructed to vaporize liquid fuel during running conditions in substantial absence of air.

75. A fuel vaporizer for an internal combustion engine equipped with an electrical system that comprises a battery and electric source powered by the engine, the fuel vaporizer constructed to vaporize liquid fuel in substantial absence of air during running conditions, the fuel vaporizer comprising:
a closed pressure chamber defining a volume;
first and second heat-transfer surfaces associated with the volume, each heated by electric power from the electrical system;
a liquid fuel supply system disposed to emit into the volume, under pressure, an expanding pattern of fuel spray of liquid from at least one outlet,
the chamber and the liquid fuel supply system being constructed and arranged relative to the first heat-transfer surface to establish between the at least one outlet and the heat-transfer surface a mixing domain in which the fuel spray, as it progresses through the volume from the outlet, is substantially heated and vaporized by mixing with recirculated, heated fuel vapor that previously has moved over and received added heat from the heat-transfer surface,
the pressure chamber and the liquid fuel supply system being constructed and arranged relative to the second heat-transfer surface to enable, under cold conditions, impact of liquid spray directly upon the second heat-transfer surface, the second heat-transfer surface being constructed to vaporize impacting spray,
the fuel vaporizer associated with a vapor outflow passage that includes a flow control, the fuel vaporizer constructed and arranged to enable flow of pressurized fuel vapor to the engine while positive pressure is maintained within the volume.

76. A diesel fuel vaporizer for an internal combustion engine equipped with an electrical system that comprises a battery and electric source powered by the engine, the fuel vaporizer constructed to vaporize liquid diesel fuel, the vaporizer comprising:
a closed pressure chamber defining a volume,
a heat-transfer surface associated with the volume and heated by electric power from the electrical system, and
a liquid fuel supply system disposed to emit into the volume, under pressure, an expanding pattern of diesel fuel spray of liquid from at least one outlet spaced from the heat-transfer surface,
the chamber and the liquid fuel supply system being constructed and arranged relative to the heat-transfer surface to establish between the at least one outlet and the heat-transfer surface a mixing domain in which the fuel spray, as it progresses through the volume from the outlet, is substantially heated and vaporized by mixing with recirculated, heated fuel vapor that previously has moved over and received added heat from the heat-transfer surface,
the fuel vaporizer associated with a vapor outflow passage which includes a flow control, the fuel vaporizer constructed and arranged to enable flow of pressurized diesel fuel vapor to the engine while maintaining positive pressure within the volume in which vaporization occurs.

77. The diesel fuel vaporizer of claim 76 includes an air inlet constructed and arranged to introduce a limited flow of pressurized air into the volume.

78. The diesel fuel vaporizer of claim 76 or 77 including a second heat-transfer surface, the pressure chamber and the liquid fuel supply system being constructed and arranged relative to the second heat-transfer surface to enable, under cold conditions, impact of liquid spray directly upon the second heat-transfer surface, the second heat-transfer surface being constructed to vaporize impacting spray to provide fuel vapor for the engine.

79. A fuel vaporizer and vapor injector for an internal combustion engine:
a closed pressure chamber defining a volume,
a heat-transfer surface associated with the volume and arranged to be heated, and
a liquid fuel supply system disposed to emit into the volume, under pressure, and in the absence of air, an expanding pattern of liquid fuel spray from at least one outlet spaced from the heat-transfer surface, the liquid fuel supply system comprising a fuel injection system constructed to inject controlled pulses of liquid fuel spray into the volume, each pulse in timed relationship with the engine and in amount suitable for a fuel charge for a combustion region of the engine, the heat-transfer surface including a transverse surface opposed to the spray and an outer wall portion surrounding the spray, the heat-transfer surface associated with a glow plug to heat the spray and produce fuel vapor, the flow control comprising a valve constructed to be opened in timed relationship with the engine at an interval following the respective pulse of liquid spray.

80. The fuel vaporizer of claim 79 in which the heat-transfer surface is cup-shaped with bottom and sides and the fuel injection system is arranged to direct the spray into, against the bottom of, the cup-shaped member.

81. The fuel vaporizer of claim 80 in which a glow plug heats the bottom of the cup-shaped member.

82. The fuel vaporizer of claim 79, 80 or 81 constructed to vaporize diesel fuel.

83. A fuel vaporizer for an internal combustion engine, the engine equipped with an electrical system that comprises a battery and electric source powered by the engine, the fuel vaporizer comprising:
a closed pressure chamber defining a volume,
at least one heat-transfer surface associated with the volume and arranged to be heated solely by the electrical system of the engine, and
a liquid fuel supply system disposed to emit into the volume, under pressure, an expanding pattern of fuel spray of liquid from at least one outlet spaced from the heat-transfer surface,
the chamber, the liquid fuel supply system and heating of the heat-transfer surface being cooperatively constructed and arranged to vaporize the fuel to produce fuel vapor under substantial pressure,
the fuel vaporizer associated with a vapor outflow passage which includes a flow control, the fuel vaporizer constructed and arranged to enable flow of pressurized fuel vapor to the engine while maintaining substantial super-atmospheric pressure within the volume in which vaporization occurs.

84. The fuel vaporizer of claim 83 constructed to vaporize liquid fuel in substantial absence of airflow.

85. The fuel vaporizer of claim 83 constructed to vaporize liquid fuel in presence of a limited flow of air into the pressure chamber.

86. The fuel vaporizer of claim 85 in which the air is injected under pressure in manner to promote atomization of the spray of liquid.

87. A fuel vaporizer having a heat-transfer surface defined by a transversely extending heat-conductive member having a general direction of extent and at least one electrically energizeable glow plug having its heated portion in intimate thermal contact with the conductive member, the axis of the glow plug being generally perpendicular to the direction of extent of the heat-conductive member.

88. The fuel vaporizer of claim 87 in which a vapor-producing heat-transfer surface comprises the inside surface of a wall member in the form of a surface of revolution, and the transversely extending heat-conductive member comprises an annular member surrounding and in thermal contact with the wall member.

89. The fuel vaporizer of claim 87 in which the transversely extending heat-conductive member comprises a heat-transfer surface comprises a member extending transversely to the direction of a spray of fuel from an injector.

90. The fuel vaporizer of claim 89 in which the member comprises a thermally conductive plate.

91. The fuel vaporizer of claim 89 in which the transversely extending member defines a bottom portion of a cup-shaped fuel vaporization chamber.

92. The fuel vaporizer of claim 89, 90 or 91 in which the transversely extending member is shaped to assist in guiding flow into a recirculating pattern for mixing.

93. A glow plug comprising an internal electrically resistive heater in the form of an elongated helical coil of a platinum alloy, an elongated, closed end outer tube of heat resistant metal defining an internal cavity in which the resistive heater coil resides, and a thermally conductive, electrically insulative filler within the tube comprised substantially of fine glass powder, insulating the heater electrically from the tube while forming a thermal conductive path therebetween.

94. The glow plug of claim 93 in which an outer end of the resistive heater coil is connected to a terminal member, the terminal member being sealed to outer structure of the glow plug by high temperature pressure seal glass.
